(19) United States
(12) Patent Application Publication
(10) Pub. No.: US 2026/0014467 A1
(43) Pub. Date: Jan. 15, 2026

(54) PROGRAM, GAME CONTROL DEVICE, GAME SYSTEM, CONTROL METHOD, AND STORAGE MEDIUM

(71) Applicant: KONAMI DIGITAL ENTERTAINMENT CO., LTD., Tokyo (JP)

(72) Inventors: Akira Sakai, Tokyo (JP); Shigeru Chiba, Tokyo (JP); Naoki Inaba, Tokyo (JP); Junki Hirai, Tokyo (JP); Kai Inoue, Tokyo (JP)

(73) Assignee: KONAMI DIGITAL ENTERTAINMENT CO., LTD., Tokyo (JP)

(21) Appl. No.: 19/332,662

(22) Filed: Sep. 18, 2025

Related U.S. Application Data
(63) Continuation of application No. PCT/JP2024/006649, filed on Feb. 22, 2024.

(30) Foreign Application Priority Data
Mar. 31, 2023 (JP) 2023-059558

(51) Int. Cl. A63F 13/54; A63F 13/35; A63F 13/61

(52) U.S. Cl. CPC A63F 13/54; A63F 13/61; A63F 13/35

(57) ABSTRACT

A terminal device for executing a control of a game in which an advertising audio can be played includes a play environment detection unit and an audibility calculation unit. The play environment detection unit detects a play environment in a period related to a playback of the advertising audio. The audibility calculation unit calculates the audibility of the advertising audio based on the play environment detected by the play environment detection unit.

### CROSS-REFERENCE TO RELATED APPLICATIONS

This application is a Continuation of International Application No. PCT/JP2024/006649, filed Feb. 22, 2024 in the Japanese Patent Office, which is based upon and claims the priority of the prior Japanese Patent Application No. 2023-059558, filed on Mar. 31, 2023, the entire contents of each of which being incorporated by reference herein.

### BACKGROUND ART

### Field of Invention

The present invention relates to a program, a game control device, a game system, a control method, and a storage medium.

### Description of Related Art

Conventionally, advertisements may be exposed in content such as games. In the case of in-game ads, the target audience for ads is players who play games or viewers when video gameplay is streamed.

Recently, there are cases where audio is used for the advertisement. Advertisements using audio are attracting attention because they are less visually disturbing than visual advertisements and are easier to leave an impression on viewers (for example, Japanese Patent Application Laid-Open Publication No. JP2009-510608).

However, with regard to audio advertisements, it may be difficult for the viewer to recognize the content depending on the audio play environment. For example, in the environment where other audio (for example, cheers of spectators of a sports game) is played at a high volume in the game while the advertising audio is being played, the advertising audio becomes difficult to hear. For this reason, even when the same audio advertisement is played, the level of awareness of the audio advertisement by the viewer differs depending on the play environment. In this point, it is difficult to properly evaluate the effectiveness of an audio advertisement, and there are currently no reasonable evaluation criteria.

Therefore, one of the objects of the present invention is to indicate a standard that can appropriately evaluate the effectiveness of an audio advertisement.

A non-transitory computer-readable storage medium in one aspect of the present invention having recorded therein a program for controlling a game in which an advertising audio can be played and that is executed by a processor of an information processing apparatus, wherein the program causes the processor to detect a play environment in a period related to a play of the advertising audio; and calculate an audibility of the advertising audio based on the play environment as detected.

A game control device in one aspect of the present invention, that includes at least one processor, and a memory cooperating with the processor and storing an instruction executable by the processor, and that executes a control of a game in which an advertising audio can be played, wherein by executing the instructions, the processor functions to detect a play environment in a period related to a play of the advertising audio; and calculate an audibility of the advertising audio based on the play environment as detected.

A control method in another aspect of the present invention, for controlling a game in which an advertising audio can be played, includes: detecting a play environment in a period related to a play of the advertising audio; and calculating an audibility of the advertising audio based on the play environment as detected.

### BRIEF DESCRIPTION OF THE DRAWINGS

FIG. 1 is a schematic block diagram illustrating an example configuration of a game system according to one embodiment of the present invention.

FIG. 2 is a diagram illustrating an example of a game screen.

FIG. 3 is a functional block diagram schematically illustrating an example of a functional configuration of a terminal device.

FIG. 4 is a functional block diagram schematically illustrating an example of a functional configuration of a play environment detection unit.

FIG. 5 is a diagram illustrating an example of the relationship between an ON/OFF setting state of an audio output and an audibility.

FIG. 6 is a diagram illustrating an example of a volume setting in a terminal device.

FIG. 7 is a diagram illustrating an example of a play state for each channel of an in-game audio at a certain timing.

FIG. 8 is a diagram illustrating an example of a frequency spectrum of an advertising audio.

FIG. 9 is a diagram illustrating an example of an output data of an advertising audio.

FIG. 10 is a schematic functional block diagram illustrating an example configuration of the relative volume detection unit.

FIG. 11 is a diagram illustrating an example relationship between with or without the use of headphones or earphones and an audibility.

FIG. 12 is a diagram illustrating another example of a game screen.

FIG. 13 is a diagram illustrating an example of a game screen after an elapse of a certain period of time from the game screen of FIG. 12.

FIG. 14 is a flowchart illustrating an example of a process related to an audibility calculation.

FIG. 15 is a flowchart illustrating an example of a play environment detection process.

FIG. 16 is a flowchart illustrating an example of an audibility calculation process of an advertising audio.

FIG. 17 is a flowchart illustrating another example of the process related to audibility calculation.

FIG. 18 is a flowchart illustrating another example of the process related to audibility calculation.

FIG. 19 is a flowchart illustrating another example of the process related to audibility calculation.

FIG. 20 is a schematic block diagram illustrating an example configuration of a distribution system according to one embodiment of the present invention.

FIG. 21 is a schematic functional block diagram illustrating an example of the functional configuration of a viewing terminal.

FIG. 22 is a schematic block diagram illustrating an example configuration of a content system according to one embodiment of the present invention.

FIG. 23 is a schematic functional block diagram illustrating an example of the functional configuration of a terminal device.

### MODES FOR CARRYING OUT THE INVENTION

Hereinafter, modes for carrying out the present invention will be described with reference to drawings.

### 1. Example System Configuration

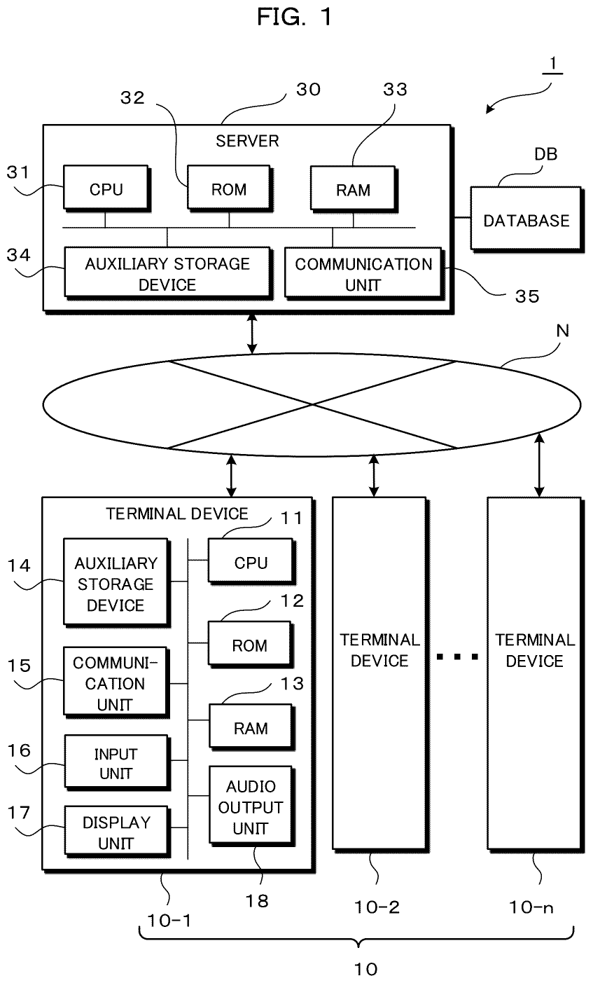

FIG. 1 is a schematic block diagram illustrating an example configuration of a game system 1 that can play an advertising audio in a game, according to one embodiment of the present invention. The game system 1 includes a plurality of terminal devices 10-n (n is a positive integer) 10-1, 10-2, . . . ) and a server 30. The terminal devices 10-n and the server 30 in the game system 1 are communicably connected to each other via a network N such as the Internet. Here, since the plurality of terminal devices 10-n have the same configuration, the plurality of terminal devices 10-n are simply described as the “terminal device 10” when not particularly distinguished.

The network N according to the present embodiment is not limited to the Internet, and as long as the terminal device 10-n and the server 30 in the game system 1 can be communicably connected to each other, for example, a dedicated line, a public line (such as a telephone line, a mobile communication line, etc.), a wired LAN (Local Area Network), a wireless LAN, or the like may be adopted, or any of the above combined with the Internet may be adopted.

The terminal device 10 to be operated by a user is a computer that the user uses to play a game. The game terminal 10 is, for example, a home game machine (stationary or portable), a personal computer, a smartphone, a mobile phone terminal, a PHS (Personal Handy-phone System) terminal, a personal digital assistant (PDA), a tablet computer, a multi-functional television receiver (so-called smart television), a commercial-use game machine installed in amusement facilities, etc., and the like.

The server 30 is a server computer that controls and manages games and advertisements. The server 30 stores, for example, the information about the user's game in association with the user ID that uniquely identifies each user in a database DB, and manages the information. Further, the server 30 stores and manages information on in-game advertisements such as audio advertisements to be played in the game a user plays in the terminal device 10, for example, in a database DB. The database DB may be provided in the server 30 or in a server computer separately provided from the server 30.

The server 30 can be configured by a single computer, but may have a functionally distributed configuration in which each function of the server 30 is distributed to a plurality of servers. For example, a game server that mainly controls and manages the game and an advertisement management server that mainly controls and manages advertisements may be configured separately.

Alternatively, a load-balanced server may be adopted by providing a plurality of servers 30 on the network N to provide redundancy (multiplexing). Further, the server 30 may be configured as a cloud server using the cloud computing technology.

### (Hardware Configuration of Terminal Device)

The terminal device 1 mainly includes a CPU (Central Processing Unit) 11, a ROM (Read Only Memory) 12, a RAM (Random Access Memory) 13, an auxiliary storage device 14, a communication unit 15, an operation unit 16, a display unit 17, and an audio output unit 18, and these components are mutually connected via a bus line including an address bus, a data bus, a control bus and the like. Note that an interface circuit, an image processing unit, a sound processing unit, or the like are interposed between the bus line and the respective constituent elements as necessary, but the illustration thereof are omitted in the drawing.

The CPU 11 is a processor that interprets and executes instructions of system software or application software (a game program, etc.) and controls the entire terminal device 10. The processor may include a hardware such as a GPU (Graphics Processing Unit), a DSP (Digital Signal Processor), or an FPGA (Field Programmable Gate Array) in addition to or instead of the CPU 11.

The ROM 12 stores programs, data, and the like necessary for a basic operation control of the terminal device 10. The RAM 13 stores various programs and data and secures a work area for the CPU 11.

The auxiliary storage device 14 stores programs, various data, and the like. For the auxiliary storage device 14, for example, a non-volatile semiconductor memory, a hard disk drive, a solid-state drive, or the like can be used.

The communication unit 15 includes a communication interface (not shown) and has a communication control function for data communication. Here, the communication control function for data communication includes, for example, an Internet connection function, a wireless LAN (Local Area Network) connection function, and a short-range wireless communication (for example, Bluetooth (registered trademark)) function using a predetermined frequency band (for example, a 2.4 GHz frequency band). The communication unit 15 transmits a connection signal for connecting the terminal device 10 to the network N based on an instruction from the CPU 11, and receives information transmitted from the communication partner side and supplies it to the CPU 11.

The input unit 16 is provided for a user to input various operation commands to the terminal device 10. Examples of the input unit 16 include a position input unit (a component of a touch panel, etc.) having a touch interface, physical buttons, a controller, an analog stick, a keyboard, a pointing device, and the like. Further, the input unit 16 may be configured such that an audio can be input by identifying an audio input from an audio input unit such as a microphone or the like.

The display unit 17 is driven based on an image display command from the CPU 11 and displays a game screen or the like. For the display unit 17, various known display device such as a liquid crystal display, an organic EL (Electro-Luminescence) display may be used. When the display unit 17 is configured as a touch panel, the terminal device 10 includes a touch input detection unit (not shown). When an indicator such as a finger or pen comes into contact with the screen, the touch input detection unit detects the contact position coordinates on the screen and supplies a coordinate signal to the CPU 11. As a result, the contact position on the screen of the display unit 17 is recognized by the CPU 11. The display unit 17 does not need to be integrated with the terminal device 10, and may be, for example, a television monitor externally connected to the terminal device 10. In the case of a television monitor or the like to which the display unit 17 is externally connected, the display unit 17 is not included in the configuration of the terminal device 10.

The audio output unit 18 includes a speaker, generates an audio signal (sound signal) based on a pronunciation instruction from the CPU 11, and outputs an audio including advertising audio, game sound effects, and the like from the speaker. The audio output unit 18 includes an output interface for outputting an audio signal to the terminal device 10 instead of or in addition to the speaker. The output interface includes a headphone jack (also referred to as an earphone jack). In addition, output ports capable of audio output other than the headphone jack, such as a USB (Universal Serial Bus) port, a Lightning (registered trademark) port, and the like are also included in the output interface. Further, for example, a wireless communication interface capable of outputting an audio signal such as Bluetooth, etc., is also included in the output interface.

Further, the terminal device 10 may include a storage media drive. Examples of the storage media drive include a DVD-ROM drive, a CD-ROM drive, a hard disk drive, an optical disc drive, a flexible disk drive, a silicon disk drive, a cassette media reader, and the like. In this case, a DVD-ROM, a CD-ROM, a hard disk, an optical disc, a flexible disk, a semiconductor memory, or the like may be used as the storage medium. The storage media drive reads image data, audio data, and program data from the storage medium, and supplies the read data to the RAM 13 or the like via a decoder.

Further, the terminal device 10 may include a hardware configuration such as a camera, an angular rate sensor (a gyro sensor), and a GPS (Global Positioning System) receiving module, etc.

### (Hardware Configuration of Server)

The server 30 mainly includes a CPU 31, a ROM 32, a RAM 33, an auxiliary storage device 34, and a communication unit 35, which are interconnected via bus lines including an address bus, a data bus, a control bus, and the like. In addition, an interface circuit is interposed between the bus line and each component as necessary. However, the illustration of the interface circuit is omitted here.

The CPU 31 interprets and executes commands of the system software and the application software to overall control the server 30. The ROM 32 stores a program necessary for basic operation control of the server 30. The RAM 33 stores various programs and data, and secures a working area for the CPU 31. The auxiliary storage device 34 is a storage device for storing programs, various data, and the like. As the auxiliary storage device 34, for example, a hard disk drive or a solid-state drive can be used.

The communication unit 35 includes a communication interface (not shown) and controls communication between the terminal devices 10-n via the network N. Further, the communication unit 35 also controls communication with other servers not shown connected to the network N. For example, in the case of a system configuration wherein the server 30 is integrated with the social networking service (SNS), the communication unit 35 of the server 30 controls the communication with the SNS server. Further, for example, the server 30 controls the communication with a video distribution server that distributes a game video played by a user to spectators. Note that the server 30 may also have a function as a distribution server. [2. Example of Audio Advertisement]

The outline of an example of the audio advertisement of the present embodiment will be explained below.

In the game system 1, various games can be executed. For example, various games can be executed regardless of game format or genre, such as sports games (games based on baseball, soccer, tennis, American football, etc.), racing games, combat games, fighting games, digital card games, etc. A game may be executed such that the terminal device 10 performs data communication with the server 30 or other terminal device 10, or may be executed by the terminal device 10 alone. In the following, a game based on baseball will be described as one example of the game to be executed on the game system 1, and other games than the baseball game will be mentioned as necessary.

### 2. Example of Audio Advertisement

The outline of an example of the audio advertisement of the present embodiment will be explained below.

In the game system 1, various games can be executed. For example, various games can be executed regardless of game format or genre, such as sports games (games based on baseball, soccer, tennis, American football, etc.), racing games, combat games, fighting games, digital card games, etc. A game may be executed such that the terminal device 10 performs data communication with the server 30 or other terminal device 10, or may be executed by the terminal device 10 alone. In the following, a game based on baseball will be described as one example of the game to be executed on the game system 1, and other games than the baseball game will be mentioned as necessary.

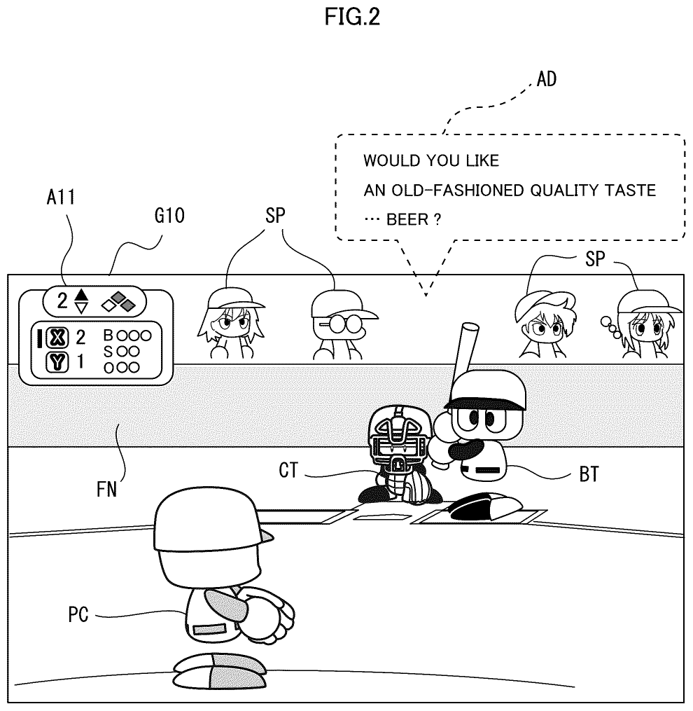

FIG. 2 illustrates an example of a game screen G10 displayed on the display unit 17 of the terminal device 10. The game screen G10 is a video or a still image that displays the progress of a baseball game in a virtual space of a virtual stadium. FIG. 2 illustrates the game screen G10 when the user performs a pitching operation. As illustrated in FIG. 2, in the scene where the pitching operation is performed, displayed is an image captured by a virtual camera disposed in the back screen BS or the like behind the pitcher character PC. For example, the game screen G10 displays various objects in the virtual game space that enter the field of view of the virtual camera, such as the pitcher character PC, the catcher character CT, the opposing team's batter character BT, the fence FN of the stadium, and the spectator character SP in the stands behind the back net. In addition, the game screen G10 also displays the game progress information display area A11, etc., which shows the current innings, runs, ball counts, out counts, on-base status, etc.

In the game, the audio (advertising audio) of the audio advertisement AD is played at a predetermined timing. For example, the advertising audio is played together with other game audios (sound effects, etc.) in the game as the voice of a salesperson (so-called ballpark vendor) who sells products in the infield stands behind the back net. FIG. 2 illustrates an example wherein with a voice of a vendor at a ballpark (not shown), the audio advertisement of “Would you like an old-fashioned quality taste . . . Beer?” (( . . . Beer is an example of a product name or service name) is played. In this case, the audio advertisement enhances the realism of the game without interfering with the progress of the game.

Alternatively, the audio advertisement may be played, for example, with the voice of the audience character SP. Further, the audio advertisement may be played, for example, with the voice of a live commentator at the live commentary seat. Further, the audio advertisement may be played as an infield announcement output from a speaker installed on the back screen of a ballpark, for example. Not limited to these, the audio advertisement may be played in any form in the game.

The advertising target of the audio advertisement may be a product, a service, or an advertisement of a provider (company, etc.) that provides a product or service.

The advertising period (audio advertisement duration) by one advertising audio can be set arbitrarily, for example, 5 seconds, 10 seconds, 30 seconds, and the like.

Audio advertisement can be played any set number of times (one or more times) as desired in the game. When an audio advertisement is played multiple times in the game, the audio advertisement duration may always be the same length, or the length of at least one audio advertisement duration may be different from the length of other audio advertisement duration(s). Further, when an audio advertisement is played multiple times in the game, for example, the advertisement target (content of the audio advertisement) may be changed, such that the first play is an audio advertisement of a product A, and the second play is an audio advertisement a of product B that is different from product A. The content of the audio advertisement can be changed by a setting operation in the server 30 provided with an advertisement management function. For example, audio advertisement information is transmitted from the server 30 to the terminal device 10 and stored therein.

The timing of playing the audio advertisement can also be set arbitrarily. For example, it may be configured such that an audio advertisement is periodically played in the game at a predetermined time from the start of the game (for example, every 30 seconds, every 1 minute, every 3 minutes, every 5 minutes, etc.). Alternatively, an audio advertisement may be played at a timing when a predetermined condition is satisfied in the game. In the case of a baseball game, any condition can be set as the condition under which the audio advertisement is played, for example, at a timing each batter character BT enters the batter's box, a timing an inning starts, a timing of changing an offense side and defense side (the timing the inning ends), a timing the game starts, etc.

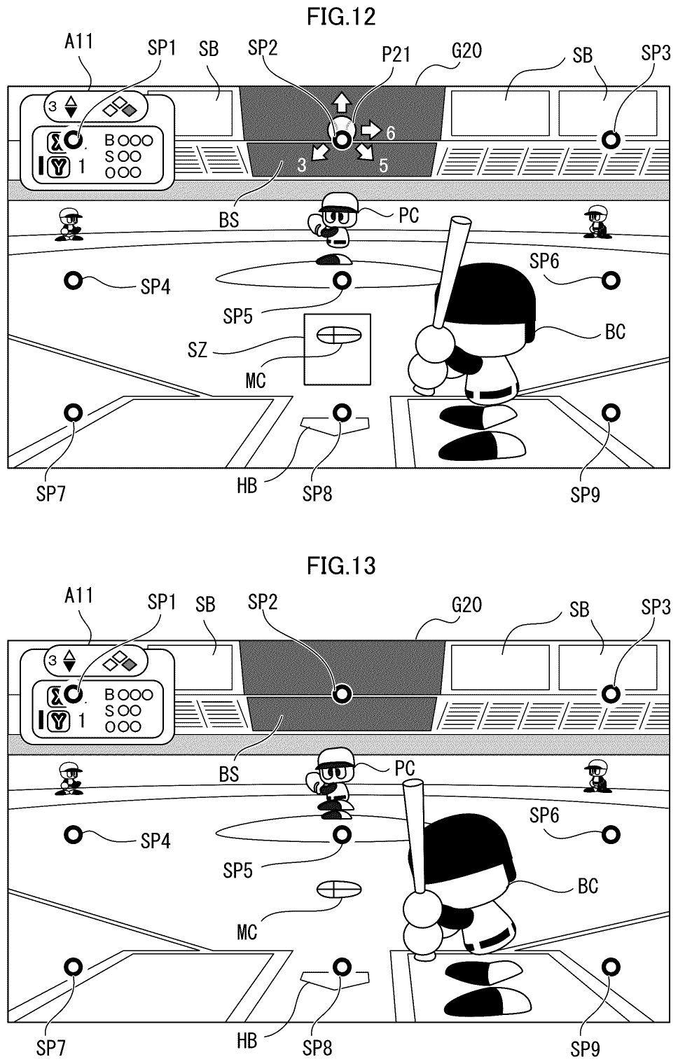

With the audio advertisement, an image advertisement using a still image or a moving image may be displayed in the game. For example, in the game screen G10 of FIG. 2, a promotion image (still image or video) for advertising a product or a service that is a subject of the audio advertisement may be displayed on the fence FN of the ballpark. Further, FIG. 12 and FIG. 13 show an example of a game screen G20 for a user to perform a batting operation. In this game screen G20, on the signboard SB installed at the top of the outfield stands of the ballpark, an advertising image may be displayed to promote the product or the service that is the subject of the audio advertisement. As described, in combination of the audio advertisement, an image advertisement can be displayed on an object in the virtual space. In this way, without interfering with the progress of the game, an improved advertising effect can be expected. In the case of also displaying an image advertisement, an image advertisement of the target product, etc., may be always displayed at all times not only in an audio advertisement duration but also a period in which the advertising audio is not being played. Alternatively, the image advertisement of the target product, etc., may be displayed only in the audio advertisement duration. Alternatively, the image advertisement of the target product may be displayed in a predetermined period before or after the advertising period (for example, 10 seconds before and after the advertising period). Further, an image advertisement such as a burner advertisement may be superimposed and displayed on the game image, with the audio advertisement. It is needless to mention that without the above-described image advertisement, the target product, etc., may be advertised only with audio advertisement.

For example, the following are the two main methods of reproducing advertising audio in the game.
Simply add advertising audio to the game audio
Installing a sound source of advertising audio in a virtual space (setting the position of the sound source)

In the former method of simply adding advertising audio to the former game audio, regardless of the progress of the game, the advertising audio is played at a predetermined volume. In this method, the user is relatively easy to recognize the advertising audio. However, since the sound field of the virtual space is ignored, the user may feel a slight discomfort.

On the other hand, in the latter case of installing an advertising audio source in the virtual space, depending on the virtual sound source position and the virtual listening position set in the virtual space, the play volume, etc., of the advertising audio changes. For example, when the virtual space is a baseball field and the sound source position is set to the infield stand behind the back net in the baseball field, the closer the listening position is to the infield stand, the louder the play volume is. The listening position is generally set to the position of the virtual camera, the position of the operation target character of the user, etc. For example, in the game screen G10 of FIG. 2 in which the user performs a pitching operation, the position of the pitcher character PC of the operation target character is the listening position. On the other hand, for example, in the game screen G20 of FIG. 12 in which the user performs a hitting operation, the position of the batter character BT, which is the character to be operated, becomes an audible position. On the other hand, for example, in the game screen G20 of FIG. 12 in which the user performs a hitting operation, the position of the batter character BT of the operation target character becomes an audible position. In this case, since the distance from the sound source position is different from the case of FIG. 2, the play volume of the advertising audio is also different. In addition, factors other than volume, that change depending on the position in the virtual space include the sound quality (for example, the farther away the sound source position and the listening position are, the more the treble component is attenuated). In addition, a reverberant sound or the like may be added according to the situation of the virtual space at the sound source position or the listening position.

As described, in the method of installing a sound source of advertising audio in the virtual space, although it may be difficult for the user to recognize the audio advertisement depending on the distance between the sound source position and the listening position, it is less likely to feel discomfort. Therefore, in this case, it can be an audio advertisement that is easy for users to accept.

As described above, the two play methods of advertising audio in the game both have strengths and weaknesses. In the game system 1 of the present embodiment, the audio advertisement may be played by any of the above two play methods.

### 3. Outline of Audibility Calculation of Advertising Audio

In the terminal device 10 or the game system 1 according to the present embodiment, at least in the period the audio advertisement is being played, the play environment inside and outside the game is detected and analyzed, the audibility of the played audio advertisement is determined, and the data is used to calculate the effectiveness of the advertisement. For example, suppose that the maximum audibility of the audio advertisement is 1 and the minimum audibility of the audio advertisement is 0, the audibility of the advertising audio is calculated based on the factors of the play environment that reduces the audibility.

Hereinafter, the audibility of the audio advertisement is referred to as “the audibility of the advertising audio” or “the audibility of the audio advertisement”.

Regarding the detection of the play environment, for example, it may be detected from the beginning to the end of the audio advertisement duration, or detected once or more times at a specific timing in the audio advertisement duration. Further, in the case of the audio advertisement of long play time, etc., an average of the results of detections at plural timings in the play period may be applied to the play environment. Here, the average value of the detected values at the plural timings may be an average value of a plural play environments detected at respective timings (if the play environment can be quantified), or an average value of multiple audibility calculated at respective multiple timings.

For example, while the audio advertisement is being played, the play environment is detected at a predetermined sampling cycle (for example, every 0.5 seconds, every 1.0 seconds, etc.), and the audibility is calculated for each sampling cycle.

As the factors that reduce the audibility of the audio advertisement, the following play environments 1 to 5 can be considered. The audibility of the audio advertisement may be calculated, based on any of these factors, or may be calculated based on a combination of two or more of these factors.
1. The ON/OFF setting state of the audio output
2. Absolute volume (the volume of advertising audio, or the volume of the in-game audio including the advertising audio)
3. Relative volume (the relative volume of the advertising audio to a volume of the in-game audio)
4. With or without the use of headphones or earphones
5. Visual information quantity

In the following, the detailed functions of the terminal device 10 and the above play environments 1 to 5 will be described.

### 4. Functional Configuration of Terminal Device

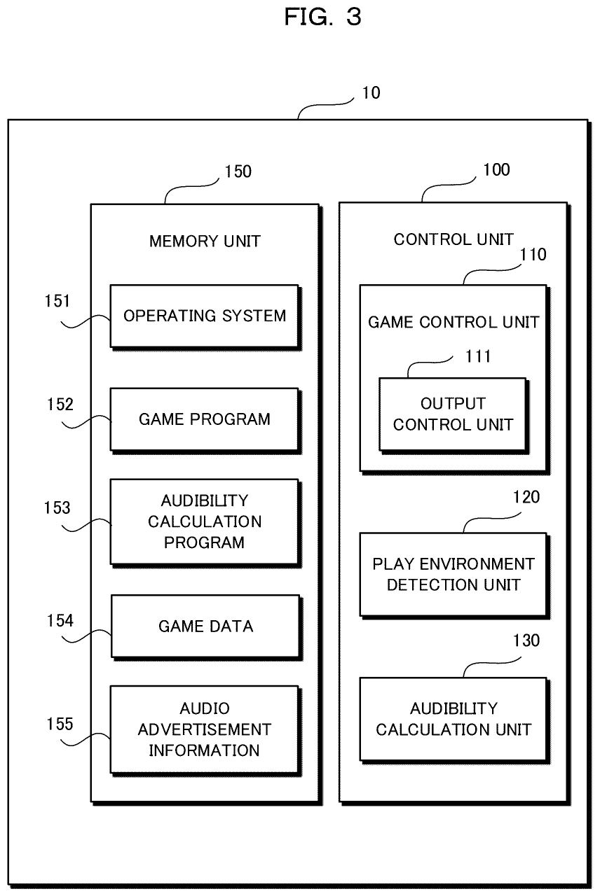

FIG. 3 is a schematic functional block diagram illustrating an example of a functional configuration of the terminal device 10. As illustrated in FIG. 3, the terminal device 10 includes a storage unit 150. The storage unit 150 stores programs and data necessary for the operation control of the terminal device 10 in the storage device (for example, the ROM 12, the RAM 13, the auxiliary storage device 14, etc.). In the present embodiment, the storage unit 150 stores an operating system (hereinafter referred to as “OS”) 151, a game program 152, an audibility calculation program 153, game data 154, and an audio advertisement information 155.

The OS 151 denotes the software for performing a basic control and a management of each part of the terminal device 10. The OS 151 provides an interface to an application program such as a game program 152 or the audibility calculation program 153, and manages each resource, such as a hardware, etc. The game program 152 is an application program for the terminal device 10 to execute a game. The audibility calculation program 153 is an example of the “program” and is an application program for performing the calculation of the audibility of the advertising audio. Note that the audibility calculation program 153 may be incorporated as a subprogram (subroutine) in the game program 152.

The game data 154 includes various data necessary for executing the game. For example, the game data 154 includes a game audio information. This game audio information includes audio data for various sounds that can be played in the game, as well as an information on their volume. Various sounds that can be played in the game include, for example, various sound effects (cheers of the audience in baseball games, the sound of hitting, catching balls, etc., the sound of wind, footsteps, gun shooting, etc.), BGM (background music), narration, etc. The audio set for the multiple channels described below and their volume are included in the game audio information. The game data 154 also includes information on various objects placed in virtual space, an parameter information on object abilities, etc.

The audio advertisement information 155 includes audio data (referred to as advertising audio data) of one or more audio advertisements that can be played in the game, their volume, play timing, information on play time, and the like. Note that since the audio of the audio advertisement (advertising audio) is a part of the audio played in the game, the audio advertisement information 155 may be included in the game audio information.

Various data including the game data 154 or the audio advertisement information 155 stored by the storage unit 150 are stored in the database DB or the auxiliary storage device 34 of the server 30, etc., and when the terminal device 10 accesses the server 30, necessary data can be downloaded to the RAM 13 or the auxiliary storage device 14 of the terminal device 10. Further, it may be configured such that the information on the results of the game executed by the terminal device 10 and the changes in data are transmitted from the terminal device 10 to the server 30 in real time or at a predetermined timing, and the data stored in the database DB or the auxiliary storage device 34 of the server 30 can be updated as appropriate. Further, for example, the data may be stored in the auxiliary storage device 14 of the terminal device 10 as necessary so that at least a portion of the game can be performed offline on each user's terminal device 10 without logging in to the server 30.

Further, the terminal device 10 includes a control unit 100. The control unit 100 is realized by the CPU 11 executing the OS 151, the game program 152, or the audibility calculation program 153. The control unit 100 includes a game control unit 110, a play environment detection unit 120, and an audibility calculation unit 130.

The game control unit 110 has a game control function that proceeds the game based on the user's input operation or the like. The game of the present embodiment is a game in which an advertising audio can be played. The game control unit 110 includes an output control unit 111. The output control unit 111 has a function as a sound output control unit that outputs a sound (including advertising audio) played in the game to the audio output unit 18. The output control unit 111 also has a function as a display control unit that outputs an image (video or still image) to be displayed as a game screen to the display unit 17.

The play environment detection unit 120 has a function of detecting a play environment during the period related to the play of the advertising audio. Here, the “advertising audio” refers to the audio of the “audio advertisement” that makes an advertisement in audio. Further, in the period of running the advertising audio, or before or after the period, a still image or video related to the advertising audio (the aforementioned image advertisement) may be displayed on the screen.

Further, the “period related to the play of the advertising audio” can be the period of running the advertising audio, a predetermined period just before running the advertising audio (for example, just 0 to 5 seconds before), or both of the above periods.

Further, the “play environment” refers to a factor that affects the auditory of a human (user) when an advertising audio or other audio is played. For example, the play environment can be the ON/OFF setting of the audio output, the absolute volume of the advertising audio, the absolute volume of the in-game audio including the advertising audio, the relative volume of the advertising audio to the volume of the in-game audio, the audio generator (the device that generates audio) a user uses (for example, headphones, earphones, speakers, etc.), the visual information quantity, the external environment sound that is the sound outside the game, such as noise outside the game, etc.

With regard to the “detecting the play environment in the period related to the play of the advertising audio”, the play environment may be detected from the beginning to the end in the period related to the play of the advertising audio, or the play environment may be detected at a specific timing in the period. Here, the specific timing may be, for example, the start timing of the play of the advertising audio, or any timing in the play period of the advertising audio. For example, the specific timing may be t seconds (t≥0) from the start of the play of the advertising audio, or at a timing 50% of the advertising period (=the total play time of one audio advertisement) has elapsed (if the advertising period is 10 seconds, it may be 5 seconds after the start of the play period of the advertising audio), or at the timing n % (0≤n≤100) % of the advertising period has elapsed.

The specific timing for detecting the play environment in the period related to the play of the advertising audio may be one time or multiple times. For example, the average value detected at a plurality of timings during the period related to the play of the advertising audio may be used as a detection value of the play environment.

The audibility calculation unit 130 has a function of calculating the audibility of the advertising audio based on the play environment detected by the play environment detection unit 120. Here, the “audibility” indicates the level (degree) to which a human (user) can hear the advertising audio played, and can be one of the indicators for evaluating the effectiveness of the advertising audio.

In the following, an example of audibility calculation will be described for each play environment that can be a factor that reduces the audibility of the audio advertisement.

### [4-1. ON/OFF Setting State of Audio Output]

The play environment detected by the play environment detection unit 120 can be the ON/OFF setting state of the audio output, based on which the audibility calculation unit 130 can calculate the audibility of the advertising audio (referred to as “the first audibility”).

Here, the “ON/OFF setting of the audio output” is a setting of whether or not an audio is output from the audio output unit 18 of the terminal device 10 that executes the game. When the audio output is set OFF, the audio is muted and the user cannot hear the advertising audio or the game audio. The “ON/OFF setting of the audio output” also includes the setting to the “mute (soundless)” that is the state where no audio is output, or the setting to cancel the mute. The mute setting corresponds to the OFF setting of the audio output, and the unmute setting corresponds to the ON setting of the audio output.

The ON/OFF setting of the audio output may be set by 1) the option setting in the game, 2) the OS setting, or 3) the hardware switch.

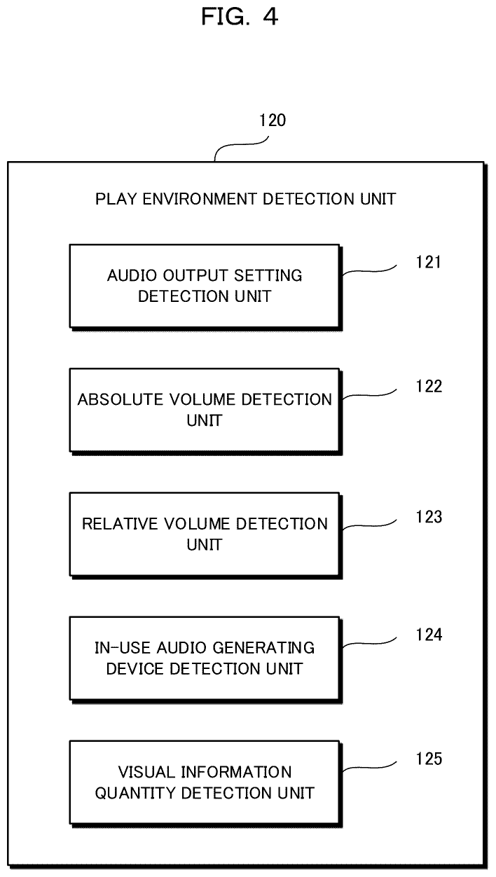

FIG. 4 is a schematic functional block diagram illustrating showing an example of the configuration of the play environment detection unit 120. The play environment detection unit 120 can be configured to include an audio output setting detection unit 121. The audio output setting detection unit 121 has a function of detecting the ON/OFF setting state of the audio output. For example, in the above case of 1), the audio output setting detection unit 121 reads the information from the storage unit 150 in which the information of the option setting in the game is stored, and detects the ON/OFF setting state of the audio output. Further, in the above case of 2) based on the OS setting, or the above case 3) based on the hardware setting, since both are based on the OS management, the audio output setting detection unit 121 detects the ON/OFF setting state of the audio output by obtaining the OS management information.

It may be configured that two or more of the above cases 1) to 3) can be set. Further, other than the above cases 1) to 3), the audio output may be set ON/OFF. When a plurality of ON/OFF settings of the audio output are possible, if any one of the audio outputs is set OFF, the audio itself is not output and the user cannot hear the advertising audio, so the first audibility A1 is “0”.

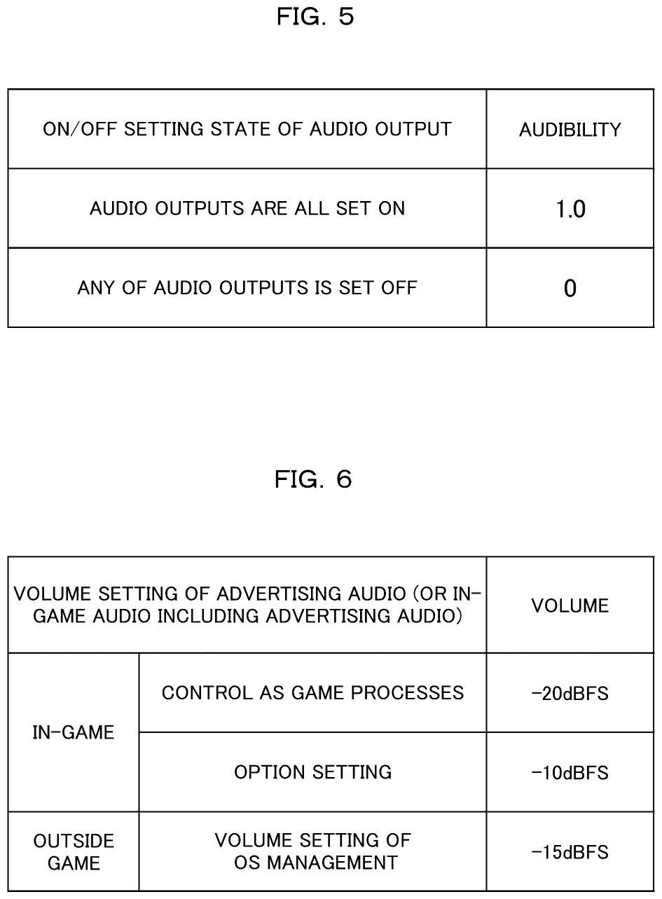

FIG. 5 is a diagram illustrating an example of the relationship between the ON/OFF setting state of the audio output and the first audibility A1. As shown in FIG. 5, in the case where a plurality of “ON/OFF settings of the audio output” are possible, when all the settings of each audio output are set ON, the first audibility A1 is “1”. On the other hand, when any of the plurality of “ON/OFF settings of the audio output” is set OFF, the first audibility A1 is “0”.

For example, the relevant information between the ON/OFF setting of the audio output illustrated in FIG. 5 and the first audibility A1 is expressed by a formula (it may be a logical formula, a logical function) or the like is stored in the storage device (the RAM 13, the auxiliary storage device 14, etc.) in advance. Then, the audibility calculation unit 130 obtains the ON/OFF setting state of each audio output detected by the play environment detection unit 120, and calculates the first audibility A1 based on the relevant information.

For example, as in the above cases of 1) to 3), assumed that there are n methods (n is a natural number of 1 or more) for the “ON/OFF setting state of the audio output” in the terminal device 10, and the state value SVn of each audio output is SVn=1 when it is ON, and SVn=0 when it is OFF. In this case, for example, the first audibility A1 can be calculated by the following equation (1).

$$A 1 = SV 1 \times SV 2 \times … \times SVn \qquad ( 1 )$$

### [4-2. Absolute Volume]

The higher the absolute volume of the advertising audio, the more easily a user is able to hear the advertising audio. Therefore, the play environment detected by the play environment detection unit 120 can be the volume of the advertising audio, based on which the audibility calculation unit 130 can calculate the audibility of the advertising audio.

Further, the higher the absolute volume of the in-game audio including the advertising audio, which the audibility calculation unit 130 can calculate the audibility of the advertising audio, the more easily a user is able to hear the advertising audio included in the in-game audio. Therefore, the play environment detected by the play environment detection unit 120 can be the volume of the advertising audio included in the in-game audio, based on which the audibility calculation unit 130 can calculate the audibility of the advertising audio.

Based on the “volume of the advertising audio” or “the volume of the in-game audio including the advertising audio” detected by the play environment detection unit 120, the audibility of the advertising audio calculated by the audibility calculation unit 130 is referred to as “second audibility”.

Here, the “volume” is not specified as long as the level can be quantitatively detected, and for example, the sound pressure level in units of “dBFS” can be one example of the “volume”. Further, for example, the loudness (aural intensity of sound) in the unit of “phon” can be another example of “volume”. Further, the amplitude of the audio waveform may also be the “volume”.

The louder the volume of the output “advertising audio” or “in-game audio including advertising audio”, the closer the second audibility to be 1. Here, factors that change the volume of the advertising audio in the game are the volume controlled by the game program (the game control unit 110) according to the progress of the game (such as the above-described example of the sound source position and the listening position of the audio advertisement), the volume setting by the option setting in the game, and the like. Outside the game, another factor that changes the volume of audio advertisement can be a volume setting by the OS management. For the volume setting based on the optional settings in the game, there are cases where the volume of the advertising audio can be set independently of other in-game audio, and the volume of the in-game audio including the advertising audio can be set, and either case may be adopted.

Thus, since there are a plurality of factors in the volume of the advertising audio, any one of these factors may be used, or two or more factors may be combined as necessary. In addition, when obtaining the volume by the in-game option setting (when the volume of the advertising audio cannot be set independently of other in-game audio) or the volume by the OS management, obtained is the volume of the in-game audio including the advertising audio.

As illustrated in FIG. 4, the play environment detection unit 120 according to the present embodiment may be configured to include the absolute volume detection unit 122. The absolute volume detection unit 122 has a function of detecting the volume of the advertising audio or the volume of the in-game audio including the advertising audio.

The advertising audio data is managed as the audio advertisement information 155, and the absolute volume detection unit 122 acquires the volume of the advertising audio controlled according to the progress of the game from the game control unit 110. Here, the method of reproducing the advertising audio controlled according to the progress of the game may be any of the above two methods (a method of simply adding the advertising audio to the game sound, or a method of installing the source of the advertising audio in the virtual space). Further, the absolute volume detection unit 122 may obtain from the game control unit 110, the volume of the in-game audio including the advertising audio controlled according to the progress of the game.

Further, in the case of an in-game option setting, the absolute volume detection unit 122 reads the information from the storage unit 150 in which the option setting information is stored, and acquires the volume of the advertising audio (or the volume of the in-game audio including the advertising audio).

Further, when the OS is set, the absolute volume detection unit 122 detects the volume of the in-game audio including the advertising audio by acquiring the OS management information.

In the following, explained is an example in which the volume setting at a certain sampling timing of the terminal device 10 is the setting illustrated in FIG. 6. In this example, the volume of the advertising audio (or the in-game audio including the advertising audio) controlled by the game control unit 110 as the game progresses is “−20 dBFS”. Further, the volume of the advertising audio based on the option setting in the game is “−10 dBFS”. In addition, the volume by the OS management is “−15 dBFS”. Here, any of the above values may be obtained, or a combination thereof may be obtained. For example, as the game progresses, only the volume of the advertising audio controlled by the game control unit 110 may be obtained to calculate the second audibility A2.

However, by combining the above volumes, a more accurate in-terminal output volume can be obtained, that is closer to the volume of the advertising audio actually reaches the user's ears. When combining the above three volumes, these volumes are added in the following manner to obtain the in-terminal output volume VO of the advertising audio, for example, by the following equation.

$$VO = - 20 dBFS - 10 dBFS - 15 dbFS = - 45 dBFS$$

Then, based on the value of the in-terminal output volume VO of the advertising audio obtained in this manner, the audibility calculation unit 130 calculates the second audibility A2. There are various methods of calculating the second audibility A2. For example, if the in-terminal output volume VO is less than −80 dBFS, the second audibility A2=0, and if the in-terminal output volume VO is 0 dBFS, the second audibility A2=1. In this case, for example, the second audibility A2 can be calculated by the following equation (2).

$$A2 = 1 - ( - VO / 80 ) \qquad ( 2 )$$

Here, if 0≤A2≤1 is 0, and the calculation result of equation (2) is A2<0, A2=0.

In practice, if the volume at or above a certain level, there may be no change in the level of audibility even when the volume is in the certain level or above. Therefore, the second audibility may be set such that when the in-terminal output volume VO is at or above −10 dBFS, the second audibility A2=1.

Other than the above-described method of referring to such volume setting information, the play environment detection unit 120 may directly detect the volume from the output data (waveform data) of the audio without referring to the volume setting information. In this case, a known algorithm can be applied to analyze the volume from the output data of the audio. For example, the volume of the advertising audio may be detected from the output data of the advertising audio controlled by the game control unit 110 as the game progresses.

By directly detecting the volume from the audio output data, it is possible to consider the volume of the advertising audio data itself as well. However, since processing is required to analyze the volume from the audio output data, the processing load becomes higher.

### [4-3. Relative Volume]

While the advertising audio is being played, other audio may be mixed due to the nature of the game. The more other audio is mixed, the more difficult to recognize the audio advertisement. Therefore, the audibility can be calculated by determining the relative volume of the advertising audio to such other audio.

Then, the play environment detected by the play environment detection unit 120 can be the relative volume of the advertising audio to a volume of the in-game audio, and based on the relative volume of the advertising audio to the volume of the in-game audio, the audibility calculation unit 130 calculates the audibility of the advertising audio (refers to as the “third audibility”).

Here, the “relative volume of the advertising audio to the volume of the in-game audio” may be the relative volume of the advertising audio to the in-game audio other than the advertising audio, or the relative volume of the advertising audio to the entire in-game audio including the advertising audio (the advertising audio+the non-advertising audio).

In the following, a concrete example of calculating the third audibility will be described.

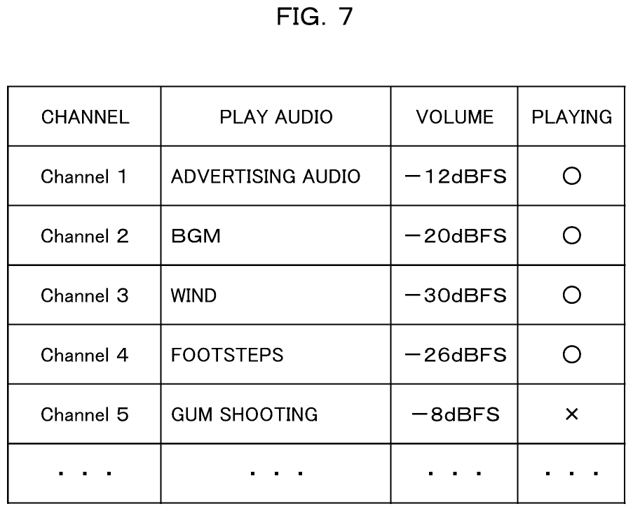

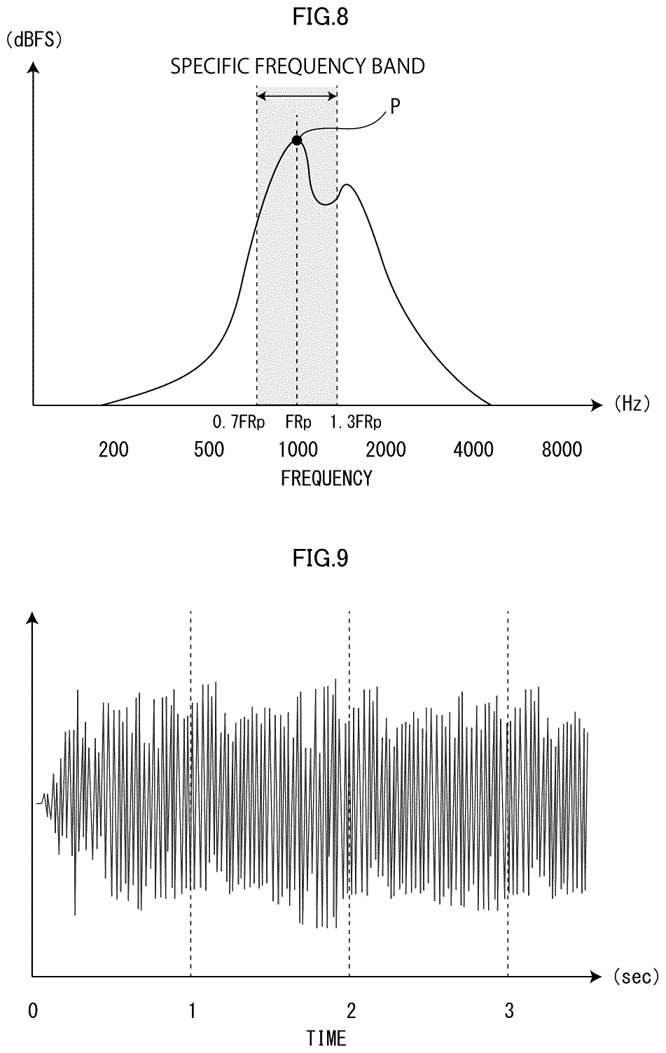

In the case where other audio in the game is taken into consideration, for example, the third audibility can be calculated from the set volume, for example, in the following manner. FIG. 7 illustrates an example of the play status of each channel of the in-game audio at a certain timing in the first-person shooting game (FPS:First-person shooter), etc. For example, the volume of in-game audio is managed for each channel, as shown in FIG. 7. the above channel may refer to as a track. To each channel, assigned is the audio to be played, and also assigned is the play volume. The volume of each channel here is not the volume of the audio data itself that is finally played on the terminal device 10, but the volume set for each channel. All the audios from these channels are synthesized after all and output from the audio output unit 18 as a single in-game audio.

In fact, there are multiple settings for the volume such as not only the setting for a mono speaker, but also for the left and right speakers, or for the surround speaker (e.g., 2.1ch, 5.1ch, 7.1ch). However, for sake of simplification, descriptions will be given through the case of the setting volume for the mono speaker (or for one of the left and right speakers, etc.).

In the example of FIG. 7, the advertising audio is set to the Channel 1. Here, the advertising audio on the Channel 1 can be played in any of the two methods mentioned above (simply adding the advertising audio to the game audio, or placing the advertising audio sound source in the virtual space).

FIG. 7 illustrates an example wherein while the advertising audio of the Channel 1 is being played, three other channel voices of the Channel 2, the Channel 3, and the Channel 4 are also being played in the game. Here, the set volume of audio other than the advertising audio is the volumes of the Channels 2 & 3 & 4 when combining the BGM of Channel 2 (set volume −20 dBFS), the sound of wind (set volume −30 dBFS) of Channel 3, and the sound of footsteps of Channel 4 (set volume −26 dBFS).

$$Channel 2 \& 3 \& 4 = 10 Log 10 ( 10 \hat{} ( - 20 dBFS / 10 ) + 10 \hat{} ( - 30 dBFS / 10 ) + 10 \hat{} ( - 26 dBFS / 10 ) ) = - 18.7 dBFS$$

On the other hand, the volume of the advertising audio of Channel 1 is set to ‘−12 dBFS’. Therefore, if the ratio of the advertising audio to the in-game audio other than the advertising audio (the relative volume of the advertising audio to the in-game audio other than the advertising audio) is the in-game relative volume RV, the relative volume RV of the advertising audio to the volume of the in-game audio can be calculated by the following equation (3).

$$RV = Volume of audio other than advertising audio / Volume of advertising audio \qquad ( 3 )$$

$$= ( - 18.7 dBFS ) / ( - 12 dBFS ) = 1.56$$

In this calculation example, it means that the advertising audio is 1.56 times more audible than other audio. In the following, the relative volume RV of the advertising audio to the volume of the in-game audio may be simply referred to as the “in-game relative volume RV”.

Additionally, since the volume value is negative, the in-game relative volume RV (the relative volume of the advertising audio to the in-game audio other than the advertising audio) is the volume of the audio other than the advertising audio/the volume of the advertising audio.

Further, the in-game relative volume RV may be obtained as the relative volume of the advertising audio to the entire in-game audio, including the advertising audio (the volume of the entire in-game audio including the advertising audio/the volume of the advertising audio).

In the example of FIG. 7, descriptions have been given through the case where three audios other than the advertising audio are played at the same time at the Channel 2, the Channel 3, and the Channel 4 while the advertising audio is being played at the channel 1 at a certain timing. At another timing, however, a channel audio other than the advertising audio to be played simultaneously while the advertising audio is being played may be different. Supposed that only the sound of gun fire of the Channel 5 (set volume −8 dBFS) is played at the same time of playing the advertising audio. Then, the in-game relative volume RV would be as follows:

$$RV = ( - 8 dBFS ) / ( - 12 dBFS ) = 0.67$$

As can be seen from this example, when the audio of the Channel 5, which is set to a relatively high volume, is played simultaneously with the advertising audio, it becomes slightly difficult to hear the audio advertisement only for the audio of the Channel 5.

As illustrated in FIG. 4, the play environment detection unit 120 according to the present embodiment may include the relative volume detection unit 123. This relative volume detection unit 123 has the function of detecting the relative volume RV of the advertising audio to the volume of an in-game audio. The relative volume detection unit 123 obtains the set volume of each channel and calculates the relative volume RV of the advertising audio to the volume of the in-game audio as described above.

Then, the audibility calculation unit 130 calculates the third audibility using the in-game relative volume RV. For example, in the case when the in-game relative volume RV (=the volume of the audio other than the advertising audio/the volume of the advertising audio), which is the ratio between the advertising audio and the in-game audio other than the advertising audio, is 3 or larger, the third audibility A3=1, the third audibility A3 can be simply calculated by the following equation (4).

$$A 3 = RV / 3 = ( Volume of audio other than the advertising audio / Volume of the advertising audio ) / 3 \qquad ( 4 )$$

Here, provided that 0≤A3≤1 is 0 and the calculation result of Equation (4) is A3>1, then A3=1.

The volume settings for each of the above channels may change dynamically as the game progresses. For example, the sound of the wind is set to be reduced when the virtual camera enters the room from outside. Also, as mentioned above, there are cases where the advertising audio also changes dynamically depending on the progress of the game (such as an example of a change in the distance between the audio source position and the listening position of the audio advertisement). In this way, it is possible that the setting volume of the advertising audio and/or the in-game audio other than the advertising audio may change while the advertising audio is being played. Therefore, for example, it is preferable to set up several time-series sampling points to obtain the average value of the respective set volumes while the advertising audio is being played.

In the above example, the volume information set for each channel has been used. However, other than this, for example, the volume may be directly analyzed from the output data of the audio of each channel to obtain the volume of the advertising audio and the volume of the in-game audio other than the advertising audio, and the in-game relative volume RV may be detected.

The number of channels mentioned above can be arbitrarily set. For example, there may be only two channels: an advertising audio channel and a channel of in-game audio other than advertising audio. Further, there may be multiple channels of advertising audio, and the channels of the advertising audio used may be switched depending on the content or the type of the audio advertisement.

Further, in the above example, calculated is the in-game relative volume RV while the advertising audio is being played. However, it is also possible to consider the volume other than the advertising audio just before the advertising audio is played (for example, 0 to 5 seconds before the advertising audio is played). This is because if the volume just before the play of the advertising audio is low, the user is likely to listen with attention, and the advertising audio can be recognized with ease.

For example, the play environment detection unit 120 detects the volume other than the advertising audio in a pre-play period of the advertising audio from a predetermined time (for example, 5 seconds) before the advertising audio starts to the start of the advertising audio. The pre-play period of the advertising audio is an example of the period related to the play of the advertising audio. Then, the audibility calculation unit 130 corrects the audibility calculated while the advertising audio is being played so that the lower the volume other than the advertising audio in the period before the start of the advertising audio, the larger is the audibility The audibility to be corrected may include not only the third audibility but also all the audibility calculated by the audibility calculation unit 130. Here, as a result of correction, if the audibility exceeds 1, the audibility is 1.

### (Frequency Band Limitation)

In addition, the relative volume RV of the advertising audio to the volume of the in-game audio mentioned above can be improved by limiting the frequency band of the audio. For example, in low-pitched sounds such as earth rumbling sound, similar low-pitched sounds are difficult to recognize; whereas high-pitched sounds such as the sound of a small bird are relatively easy to recognize.

The frequency band may be limited to the entire frequency band used in the advertising audio, or limited to the band mainly used in the advertising audio or the band that represents the characteristics of the advertising audio of the entire frequency band.

Therefore, the play environment detected by the play environment detection unit 120 may be referred to as the relative volume of the advertising audio limited to a specific frequency band to the volume of the in-game audio, and based on the in-game relative volume RV, the audibility calculation unit 130 may calculate the audibility (the third audibility) of the advertising audio.

Here, the “specific frequency band” refers to a specific frequency band that includes at least the main frequency band of the advertising audio. The “main frequency band of the advertising audio” refers to the frequency band mainly used and/or the frequency band that is essential for recognizing the advertising audio. The “specific frequency band” can also be a frequency band that represents the characteristics of the advertising audio. The “specific frequency band” may be the entire frequency band used in the advertising audio (excluding the frequency band not used in the advertising audio).

Further, the “specific frequency band” may be determined beforehand (e.g., 300 to 1000 Hz for male voice advertisements, 700 to 1500 Hz for female voices, etc.). Alternatively, the “specific frequency band” may be set to a frequency band extracted as the frequency band of the advertising audio mainly used based on the spectral analysis such as FFT (Fast Fourier Transform) analysis while the advertising audio is being played. For example, the band with ±a % (0<a<100, e.g., a=30) of the band peak in the frequency spectrum of the FFT-analyzed advertising audio can be set to the “specific frequency band”.

FIG. 8 illustrates an example of the frequency spectrum as a result of spectral analysis of the output data of the advertising audio by FFT, etc., (e.g., the above-described output data of the advertising audio of the Channel 1). FIG. 8 illustrates an example in which in the frequency spectrum of the advertising audio, with the band peak of the frequency FRp of the peak P, a frequency band FRp with 30% is set to the specific frequency band.

For example, the volume of a specific frequency band (band volume) of an advertising audio can be extracted from the output data of the advertising audio by the FFT analysis, etc.

Further, the volume of the specific frequency band (band volume) of the audio other than the audio advertisement can be extracted from the output data of the in-game audio other than the advertising audio (the output data of the in-game audio excluding the advertising audio) by the FFT analysis, etc.

From the band volume of the advertising audio and the band volume other than the audio advertisement in the extracted specific frequency band, the in-game relative volume RV in the specific frequency band can be calculated by applying the above equation (3), and the third audibility A3 can be calculated by applying the above equation (4).

By the way, language sounds are composed of vowels and consonants. In general, consonants have smaller sounds than the vowels and contain higher frequencies. However, it is important to listen to the consonants in order to listen to and recognize the language. Therefore, bands for consonant discrimination (e.g., 1500 to 2500 Hz, 4000 to 5000 Hz, etc.) may be included in the “specific frequency band”. For example, in general, for audio frequencies of the consonants, the band peaks (center frequency) are 4800 to 5000 Hz for the consonant “sa”, 4100 Hz for the consonant “si”, 5000 Hz for the consonant “su”, 4900 Hz for the consonant “se”, and 4300 Hz for the consonant “so”. For example, the frequency band containing the band peak of the consonants that are particularly important to recognize languages (e.g., “sa”, “si”, “su”, “se”, “so”; “ta”, “chi”, “tsu”, “te”, “to”, etc.) is set as the frequency band for consonant discrimination. Since the frequency bands differ also among consonants, the number of the frequency band for consonant discrimination is not limited to one, and two or more frequency bands may be set for consonant discrimination.

The band volume of the advertising audio and the band volume other than the audio advertisement may be taken as the average value in the advertising audio duration, for example, and the third audibility A3 may be calculated using the average value.

Alternatively, it may be configured such that the audio advertisement duration is divided into multiple segmented periods, and the band volume of the advertising audio limited to a specific frequency band and the band volume other than the audio advertisement are extracted for each segmented period (referred to as the segment period), and the third audibility A3 is calculated for each segment period. FIG. 9 illustrates an example of the output data (waveform data) of the advertising audio. FIG. 9 illustrates an example where the audio advertisement duration is divided into several segmented periods of a certain period of time (divided in a unit of a second). The length of the segment period is not limited to 1 second and can be set arbitrarily. As described, in the case where the play period of the advertising audio (the audio advertisement duration) is divided into multiple segments, the bandwidth usage of the advertising audio may be considered for each segment period. In other words, a specific frequency band may be set for each segment period (in other words, a specific frequency band set for at least one of several segment periods may be different from a specific frequency band set for other segment periods). In this way, by considering the bandwidth usage for each segment period and setting the specific frequency band suitable for each segment period, the third audibility A3 can be accurately calculated even in the case where different bandwidth usages exist within the advertising period of one audio advertisement such as in a female voice in the first half and in a male voice in the second half.

It is desirable to extract the bandwidth usage (determine a specific frequency band) for the advertising audio beforehand. However, the bandwidth usage may be extracted while the advertising audio is being played. When the bandwidth usage is extracted beforehand for the advertising audio, the information of a specific frequency band is associated with the audio data of the audio advertisement. Then, the audio data of the audio advertisement and the information of the specific frequency band are stored as the audio advertisement information 155 in the storage device (the RAM 13, the auxiliary storage device 14, etc.) of the terminal device 10. Then, while the advertising audio is being played, the information of the specific frequency band is read from the storage device, and the relative volume RV of the advertising audio limited to the specific frequency band to the volume of the in-game audio is calculated, and then the third audibility A3 is calculated.

On the other hand, in the case of extracting the bandwidth usage (determining the specific frequency band) while the advertising is being played, the band, etc. mainly used by the advertising audio is determined as the specific frequency band by the spectral analysis while the advertising audio is being played, and the band volume of the advertising audio in the specific frequency band is detected from the result of the spectral analysis. Further, the detection of the band volume of the audio other than advertising audio is as follows. That is, since the specific frequency band to be limited is still unknown while the advertising audio is being played, the audio data other than the advertising audio while the advertising audio is being played is temporarily stored in a storage device (RAM 13, etc.), and after the advertising audio duration ends (after the segmented period of playing the advertising audio ends in the case of dividing the advertising period into segmented periods), the band volume of the audio data other than the advertising audio is detected in the specific frequency band as determined.

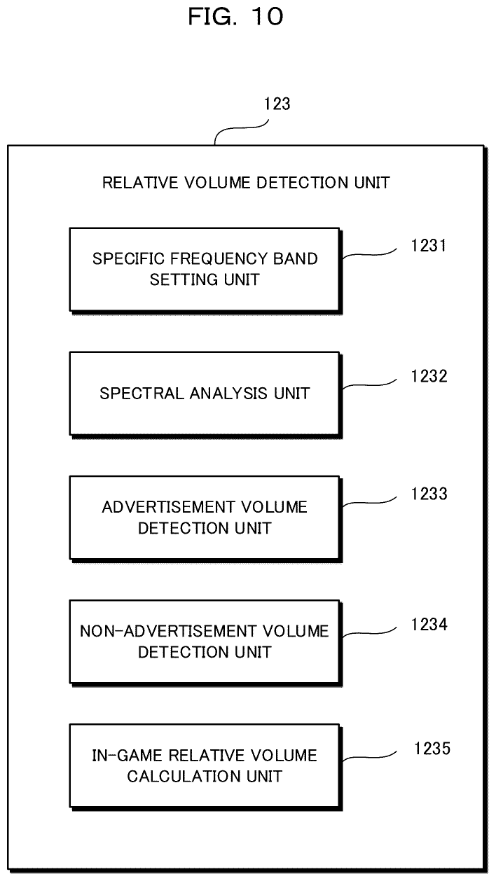

FIG. 10 is a schematic functional block diagram illustrating an example of the relative volume detection unit 123. The relative volume detection unit 123 includes a specific frequency band setting unit 1231, a spectral analysis unit 1232, an advertisement volume detection unit 1233, a non-advertisement volume detection unit 1234, and an in-game relative volume calculation unit 1235.

The specific frequency band setting unit 1231 has a function of setting a specific frequency band. In the case where the specific frequency band is extracted beforehand for the advertising audio, the specific frequency band setting unit 1231 sets a specific frequency band by obtaining the information of the pre-extracted specific frequency band. Further, the specific frequency band setting unit 1231 may extract a specific frequency band while the advertising audio is being played as mentioned above, and set the extracted specific frequency band.

The spectral analysis unit 1232 has a function of making a spectral analysis of the advertising audio or the in-game audio other than the advertising audio by the FFT, etc. The results of the spectral analysis of the advertising audio by the spectral analysis unit 1232 are used for the specific frequency band setting unit 1231 to determine the specific frequency band, or for the advertisement volume detection unit 1233 to detect the band volume of the advertising volume limited to the specific frequency band. The results of the spectral analysis of the in-game audio other than advertising audio by the spectral analysis unit 1232 are used by the non-advertisement volume detection unit 1234 to detect the band volume of the in-game audio other than the advertising audio limited to the specific frequency band.

The advertisement volume detection unit 1233 has a function of detecting a band volume of the advertising audio limited to the specific frequency band. The non-advertisement volume detection unit 1234 has a function of detecting the band volume of the in-game audio other than the advertising audio limited to the specific frequency band. The in-game relative volume calculation unit 1235 has a function of calculating the in-game relative volume RV of the advertising audio based on the band volume of the advertising audio detected by the advertisement volume detection unit 1233 and the band volume of the in-game audio other than the advertising audio detected by the non-advertisement volume detection unit 1234. For example, the in-game relative volume calculation unit 1235 calculates the in-game relative volume RV by applying the above equation (3).

[4-4. With or without Use of Headphones or Earphones]

In general, listening with headphones or earphones is easier for a user to recognize the audio than the audio played through a speaker because it is likely that the audio is played louder, and it is less likely that the audio contains external noises. Therefore, the play environment detected by the play environment detection unit 120 can be with or without the use of headphones or earphones, and based on this play environment, the audibility calculation unit 130 calculates the audibility of the advertising audio (refers to as the “fourth audibility”).

Here, the above condition “with or without the use of headphones or earphones” refers to as the play environment of whether or not the user is using headphones or earphones as a means of listening to the advertising audio or other audio being played.

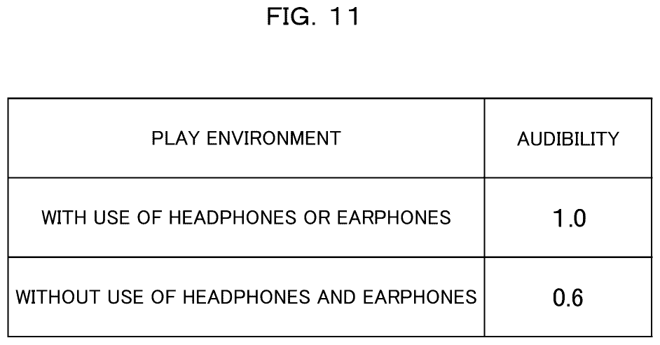

FIG. 11 illustrates an example of the relationship between with or without the use of headphones or earphones and the fourth audibility A4. As illustrated in FIG. 11, in the play environment where headphones or earphones are used, the fourth audibility A4 is “1”. On the other hand, in the play environment where neither headphones nor earphones are used, the fourth audibility A4 is “0.6”. This is just an example, and as long as the fourth audibility A4 is greater when headphones or earphones are used than that when they are not used, it is not limited to the values shown in FIG. 11.

As shown in FIG. 4, the play environment detection unit 120 may be configured to include an in-use audio generating device detection unit 124. The in-use audio generating device detection unit 124 has a function of at least detecting with or without the use of the audio generating device that a user uses is headphones or earphones. Here, the audio generating device includes headphones, earphones, speakers, etc. The in-use audio generating device detection unit 124 may detect the audio generating device used by a user is specifically, which one of the headphones, the earphones, or the speakers. The in-use audio generating device detection unit 124 can detect “with or without the use of headphones or earphones” by various methods as exemplified below.

In the case where the terminal device 10 (the information processing device such as smartphones, and game devices, etc.) that executes a game is equipped with a headphone jack (also called an earphone jack), “with or without the use of headphones or earphones” can be detected, for example, via the operating system by determining if the headphone terminal or the earphone terminal is plugged into the headphone jack.

The environment of“with or without the use of headphones or earphones” can be detected also in the case where the terminal device 10 executing the game has an output port that can output audio other than the headphone jack (for example, the USB (Universal Serial Bus) port, the Lightning (registered trademark) port, etc.). For example, it is possible to detect via the OS, whether or not the headphones or the earphones are connected directly or via the head phone jack conversion adaptor to the output port capable of outputting audio.

Further, “with or without the use of headphones or earphones” can also be detected in the case where the terminal device 10 executing the game is equipped with a wireless communication function for connecting wireless headphones or wireless earphones. The wireless communication function includes, for example, the function of short-range wireless communication (e.g., Bluetooth (registered trademark)) using a predetermined frequency band (e.g., 2.4 GHz frequency band). For example, whether a device connected to the wireless port capable of audio output is the wireless headphones or the wireless earphones can be detected via the OS.

Further, “with or without the use of headphones or earphones” may be determined in the following manner. That is, an image of a user's head, including the area around the ears is captured by a camera built into the terminal device 10 or a camera connected to the terminal device 10 by wire or wirelessly and whether or not the user is using headphones or earphones is determined by the image recognition process. To this image recognition process, a known image processing algorithm can be applied.

Further, “with or without the use of headphones or earphones” can be detected also in the following manner. That is, in the case where the built-in speaker of the terminal device 10 is used, the use of the built-in speaker can be detected via the OS. Basically, the use of the built-in speaker and the use of headphones or earphones are alternative, and it can be determined that headphones or the like are not used while the built-in speaker is used.

Although in-game audio is output from the terminal device 10, there is a possibility that an external speaker connected to the terminal device 10 by wire or wireless is used instead of headphones or earphones. In this case, “with or without the use of headphones or earphones are used” may be detected in the following manner.

That is, an external voice is detected (input) by a microphone (sound collector) built into the terminal device 10 or a microphone connected to the terminal device 10 by wire or wireless, and whether the external audio includes the in-game audio (including advertising audio) currently being played is detected by a known audio analysis algorithm. If the external audio input from the microphone contains in-game audio, it can be determined that an external speaker is being used. In this case, it can be determined that the headphones or earphones are not used. On the other hand, if the external voice input from the microphone does not include the in-game audio, it can be determined that headphones or earphones are used. In addition, if only the in-game audio is detected below the predetermined volume (volume leaking from headphones, etc.), it may be determined that the external audio input from the microphone does not include the in-game audio, and therefore the headphones or earphones are used.

### [4-5. Visual Information Quantity]

The audibility of the advertising audio may be calculated by taking into account the visual information quantity of the visual displayed in the period related to the play of the advertising audio. Here, the “visual information quantity” refers to the quantity of a visual information that the user receives from the visual. In general, the more information in the visual, the more conscious of sight, and the less conscious of hearing. Therefore, it may be configured that in the period related to the play of the advertising audio, the visual information quantity received from the game screen is estimated, and the visual information quantity as estimated is reflected in the audibility of the advertising audio. The more information in the visual, the lower the audibility of the advertising audio.

Therefore, the play environment detected by the play environment detection unit 120 can be the visual information quantity of the visual displayed on the screen displaying the game, based on which the audibility calculation unit 130 calculates the audibility of the advertising audio (referred to as the “fifth audibility”). Here, the “visual” can be a still image or a video.

As illustrated in FIG. 4, the play environment detection unit 120 can be configured to include a visual information quantity detection unit 125. The visual information quantity detection unit 125 has a function of detecting the information quantity of the visual displayed on the screen on which the game is displayed. The visual information quantity detection unit 125 can detect the visual information quantity by various methods of the examples below.

For example, the time series change in visual corresponds to an example of the “visual information quantity”. For example, in the case where the position or the orientation of the virtual camera for generating the visual of the game (game screen) are changed, the time series change in visual becomes larger compared to the case where the virtual camera is fixed. For example, it may be configured such that a plurality of specific positions in the game screen are set as sampling points, and at these sampling points, “changes in color between frames” while the advertising audio is being played are periodically obtained (for example, in the sampling cycle of every 1 second) to detect the “visual information quantity”. Alternatively, for the plurality of sampling points in the game screen, with or without a change in pixel information (that is, whether or not the pixel information has changed from the previous sampling timing) may be determined at every predetermined sampling cycle, to detect the “visual information quantity”. As long as the time series change in visual can be detected, the method of detecting the “visual information quantity” is not limited to the above.

Specific examples will be described using the game screen G20 illustrated in FIG. 12 and FIG. 13. FIG. 12 and FIG. 13 denote the game screen G20 for the user to perform a batting operation, and the visual of the game screen G20 of FIG. 13 is displayed after a predetermined time (for example, 1 second) from the visual displayed on the game screen G20 of FIG. 12. In the scene where the batting operation is performed, displayed is the visual (image) captured by the virtual camera placed on the catcher's side of the home base HB. On the game screen G20 of FIG. 12, displayed are, for example, the batter character BT to be operated by the user, the pitcher character PC of the opposing team, the strike zone SZ, the meat cursor MC, etc. In addition, various objects in the virtual game space that enter the angle of view of the virtual camera are also displayed, such as the back screen BS, the billboard SB, etc. Further, on the game screen G20 of FIG. 12, a part P21 indicating information on a ball type (so-called arsenal) that can be pitched by the pitcher character PC, a game progress information display area A11, and the like are displayed. In this example, the part P21 and the strike zone SZ are displayed until the pitcher character PC starts a pitching operation, as shown in FIG. 12; however, as shown in FIG. 13, when the pitcher character PC raises one leg and starts the pitching motion, these are deleted from the game screen G20.

FIG. 12 and FIG. 13 illustrates an example in which nine sample points SP1 to SP9 of 3 rows×3 columns are provided in the game screen G20 to detect the amount of change in the visual over time. At a plurality of sample points SP1 to SP9, while the advertising audio is being played, a “change in color between frames” is periodically acquired (for example, with a sampling cycle of every 1 second) and compared. When comparing the two visuals of FIG. 12 and FIG. 13, the position and the orientation of the virtual camera are the same, and therefore most of the sample points do not change. However, only at the sample point SP2 at the center of the upper row, the color of the pixel has changed, for example, from blue to black, depending on with or without the part P21. Such change in the visual is extracted to be considered as the change in the visual over time. For example, with a predetermined sampling cycle, it is detected how many points of the sample points SP1 to SP9 have changed between the previous sampling timing and current sampling timing. Then, after the advertising audio duration ends (after the segmented period of playing the advertising audio ends in the case of dividing the advertising period into segmented periods), the sum value (or an average value) of the number of changes in the sample points is obtained.

For example, assumed that the amount of change in the visual over time is “C”, and the sum value of the number of changes at the sample points is “V”. The amount of change C in the visual becomes larger as the sum value V of the number of changes at the sample points increases. For example, the amount of change C in the visual can be expressed as a function of V by the following equation (5).

$$C = f ( V ) = a \times V \qquad ( 5 )$$

Here, “a” in the equation (5) is an arbitrary coefficient.

Further, the fifth audibility A5 becomes larger as the amount of change C in the visual decreases. For example, the fifth audibility A5 can be expressed as a function of C by the following equation (6).

$$A 5 = f ( C ) = b / C \qquad ( 6 )$$

Here, “b” in equation (6) is an arbitrary coefficient.

The number or the positions (coordinates) of the sample points to be set in the screen are not limited to the above, and can be set arbitrarily. Further, at each sample point, a change in one pixel may be detected, or a change in a pixel group of a predetermined size (area) may be detected. In the case of the pixel group of sample points, each point having a predetermined size, it may be determined that the sample point has changed even when one of the pixels has changed, or when a predetermined percentage or more (for example, 30% or more) of the pixels in the pixel group has changed. Alternatively, the number of pixels changed is counted for each sample point, and the respective numbers of pixels changed of all the sampling points are aggregated to be a sum value V of the number of pixels changed. Not limited to the above, as long as the amount of change in the visual over time can be detected, any method can be adopted.

Further, the number of colors used in the visual corresponds to an example of the “visual information quantity”. In general, visual in which many colors are used tend to be more conscious of sight, so the consciousness of hearing tends to decrease. The more colors used in the visual, the greater the visual information quantity, and therefore the lower is the fifth audibility.

Further, the brightness of the visual (the information on the brightness of the visual) corresponds to an example of the “visual information quantity”. In general, a bright visual tends to be more conscious of sight, while a dark visual tends to be more conscious of hearing. The brighter the visual, the greater the visual information quantity, and therefore the lower is the audibility.

In addition, the contrast level of the visual corresponds to an example of the “visual information quantity”. In general, the higher the contrast of the visual, the more conscious of sight, while the lower the contrast of the visual, the more conscious of hearing. The higher is the contrast of the visual, the greater the visual information quantity, and therefore the lower is the fifth audibility.

### 5. Aspect of Combination

The methods of calculating the basic audibility have been described in the above. For the described methods of calculating the audibility of the advertising audio based on various factors that reduce the audibility of the audio advertisement, all or same can be combined as necessary.

The audibility of the comprehensive advertising audio A, that combines the first audibility A1 based on the ON/OFF setting state of the audio output, the second audibility A2 based on the absolute volume, the third audibility A3 based on the relative volume, the fourth audibility A4 based on with or without the use of headphones or earphones, and the fifth audibility A5 based on the visual information quantity, can be expressed, for example, by the following equation (7).

$$A = A 1 \times A 2 \times A 3 \times A 4 \times A 5 \qquad ( 7 )$$

The audibility A of the advertising audio can be obtained from at least one of the first audibility A1 to the fifth audibility A5. Therefore, in the example of above equation (7), the application of one or some of the first audibility A1 to the fifth audibility A5 may be omitted to calculate the audibility A of the advertising audio.

For example, in the terminal device 10, in the following conditions:
The ON/OFF settings of the audio output are all set ON (the first audibility A1=1.0);
The advertising audio is played at −10 dBFS (the second audibility A2=0.88);
In-game relative volume RV=2 (the ratio of the advertising audio to the in-game audio other than the advertising audio is 2) (the third audibility A3=0.67); and
Use of headphones (the fourth audibility A3=1.0);
the audibility A of the advertising audio is

$$A = A 1 \times A 2 \times A 3 \times A 4 = 1. \times 0.88 \times 0.67 \times 1. = 0.59$$

In this example, the application of the fifth audibility A5 is omitted.

Then, the calculated value of the audibility A of the advertising audio can be used as one of the coefficients to evaluate the effectiveness of the adverting audio.

Not limited to the above, for example, the audibility A of the advertising audio may be calculated by equation (8).

$$A = γ 1 \times A 1 \times ( γ 2 \times A 2 + γ 3 \times A 3 + γ 4 \times A 4 + γ 5 \times A 5 ) \qquad ( 8 )$$

In the above Equation (8), y1 to y5 are arbitrary coefficients greater than 0. The coefficients y1 to y5 may all be the same value, or at least one coefficient may be different from other coefficients.

In the above Equation (8), the applications of some of the first audibility A1 to the fifth audibility A5 may be omitted to calculate the audibility A of the advertising audio.

Furthermore, weights may be assigned to the first audibility A1 to the fifth audibility A5, that are to be incorporated into the audibility A of the advertising audio. For example, for the fifth audibility A5 based on the visual information quantity, the weight may be set smaller than those of other audibility A1 to A4 directly related to the advertising audio. For example, if the above equation (8) is applied, the value of the coefficient y5 may be set smaller than the values of the coefficients y1 to y4.

FIG. 4 shows an example configuration in which the play environment detection unit 120 includes the audio output setting detection unit 121, the absolute volume detection unit 122, the relative volume detection unit 123, the in-use audio generating device detection unit 124, and the visual information quantity detection unit 125 in order for the audibility calculation unit 130 to calculate the first audibility A1 to the fifth audibility A5. However, the regenerative environment detection unit 120 only needs to have at least one of these units 121 to 125, and one or more of these units 121 to 125 can be omitted as necessary.

### 6. Processing

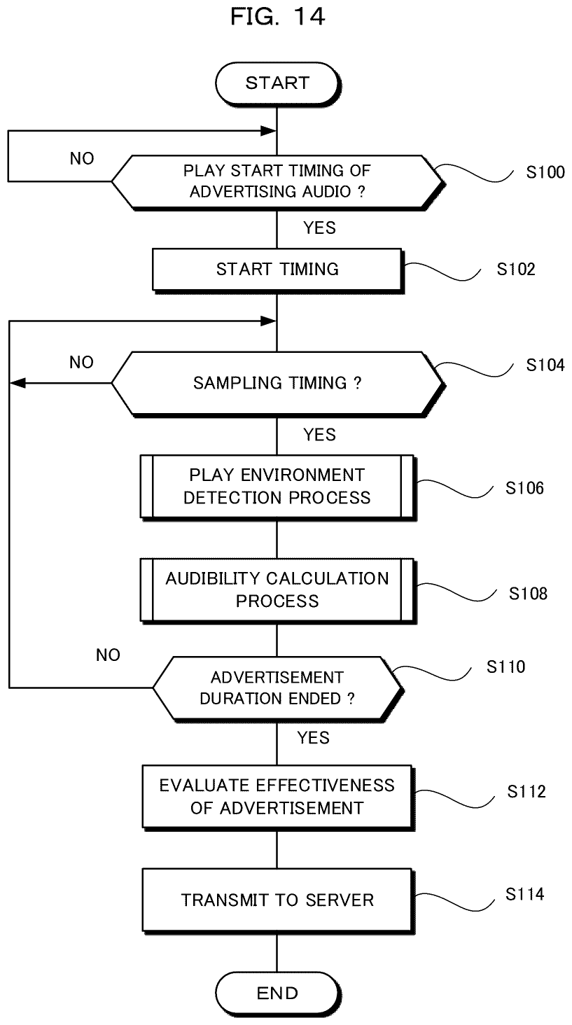

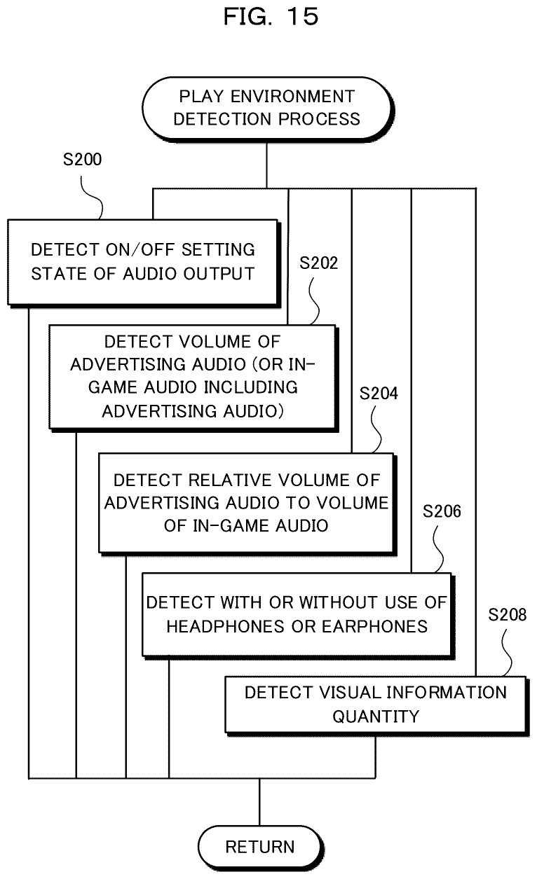

Next, an example of the processing performed by the terminal device 10 of the present embodiment will be described below. FIG. 14 is a flowchart illustrating an example of the processing related to the calculation of the audibility executed on the terminal device 10 side. The processing described below is realized by the execution of the audibility calculation program 153 (or the game program 152 including the audibility calculation program 153) stored in the memory unit 150 by the control unit 100 (the CPU 11 of the terminal device 10) (the same applies to the processing referring to the respective flowcharts of FIG. 15 to FIG. 19).

If the play environment is detected at least once in the audio advertisement duration (for example, 10 seconds), the audibility of the advertising audio can be calculated. In FIG. 14, however, explained is an example wherein multiple sampling timings are set up in the advertisement duration, and the audibility is calculated by detecting the play environment multiple times.

The control unit 100 starts timing (S102) when the play of the advertising audio starts while executing the game (YES in S100) and determines whether the sampling timing has come (S104). Here, when the sampling timing has come (YES in S104), the control unit 100 performs the play environment detection process to detect the play environment while the advertising audio is being played, and stores the detected play environment in the memory unit 150 (S106).

FIG. 15 is a flowchart illustrating an example of a play environment detecting process.

The control unit 100 detects the ON/OFF setting state of the audio output as described above, and stores the information of the detected audio output setting state in the memory unit 150 (S200).

The control unit 100 detects the volume (absolute volume) of the advertising audio (or the in-game audio including the advertising audio) as mentioned above, and stores the detected volume information in the memory unit 150 (S202).

Then, the control unit 100 detects the in-game relative volume of the advertising audio as mentioned above, and stores the detected in-game relative volume information in the memory unit 150 (S204). Further, in S204, the relative volume of the advertising audio limited to a specific frequency band to the volume of the in-game audio may be detected.

Then, the control unit 100 detects with or without the use of headphones or earphones are used as described above, and stores the information of with or without the use of headphones or earphones is stored in the memory unit 150 (S206).

The control unit 100 detects the visual information quantity of the visual displayed on the screen displaying the game as mentioned above, and stores the detected information on the visual information quantity in the memory unit 150 (S208).

FIG. 15 shows an example of performing each process of steps S200 to S208 at the same time, for example, by concurrent processing or parallel processing, but each process of steps S200 to S208 may be executed sequentially by sequential processing (in this case, the processing has no particular order).

FIG. 15 shows an example of performing five processes in steps S200 to S208; however, as long as at least one of these processes is performed, the audibility of the advertising audio can be calculated, and one or more processes can be omitted.

Referring back to FIG. 14, after the play environment detection processing of step S106, the control unit 100 performs the audibility calculation process to calculate the audibility of the advertising audio, and stores the calculated audibility information in the memory unit 150 (S108).

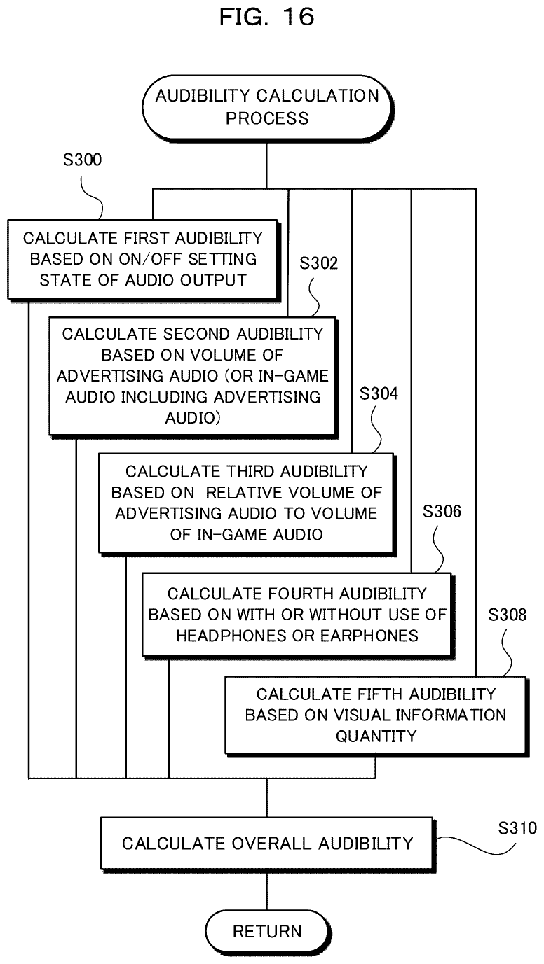

FIG. 16 is a flowchart illustrating an example of the audibility calculation process of advertising audio.

As mentioned above, the control unit 100 calculates the first audibility A1 based on the ON/OFF setting state of the audio output, and stores the information of the calculated first audibility A1 in the memory unit 150 (S300).

As mentioned above, the control unit 100 calculates the second audibility A2 based on the volume of the advertising audio (or the in-game audio including the advertising audio), and stores the information of the calculated second audibility A2 in the memory unit 150 (S302).

Further, the control unit 100 calculates the third audibility A3 based on the in-game relative volume of the advertising audio, and stores the information of the calculated third audibility A3 in the memory unit 150 (S304).

Further, the control unit 100 calculates the fourth audibility A4 based on with or without the use of headphones or earphones are used, and the information of the calculated fourth audibility A4 is stored in the memory unit 150 (S306).

The control unit 100 then calculates the fifth audibility A5 based on the visual information quantity of the visual displayed on a screen displaying the game, and stores the information of the calculated fifth audibility A5 in the memory unit 150 (S308).

In FIG. 16, the example has been shown in the case where respective processes of steps S300 to S308 are performed at the same time, for example, by concurrent processing or parallel processing, However, respective processes of steps S300 to S308 may be executed sequentially by sequential processing (in this case, the processing has no particular order).

In the example of FIG. 16, five processes in steps S300 to S308 are executed; however, as long as at least one of these processes is executed, the audibility of the advertising audio can be calculated, and one or more processes may be omitted.

Then, the control unit 100 combines the first audibility A1 to the fifth audibility A5 calculated based on different play environments (e.g., applying the above equation (7)) to calculate the comprehensive audibility A, and stores the information of the calculated comprehensive audibility A in the memory unit 150 (S310).

In the case where four of the five processes in steps S300 to S308 are omitted, the step S310 can be omitted.

Referring back to FIG. 14, after the audibility calculation process of step S108, the control unit 100 determines if the audio advertisement duration has ended (S110). If the audio advertisement duration has not ended (NO in S110), the sequence goes back to step S104. The processes of steps S104 to S110 are repeated until the end of the advertising duration (YES in S110). As a result, in the advertising duration, at each sampling timing, the play environment is detected, and the audibility of the advertising audio is calculated.

If the audio advertisement duration has ended (YES in S110), the control unit 100 evaluates the effectiveness of the advertising audio based on the audibility of the advertising audio calculated at each sampling timing (S112). For example, the control unit 100 evaluates the effectiveness of the advertising audio by taking the average or the sum value of multiple audibility values obtained at respective sampling timings as one of the coefficients to evaluate the the effectiveness of the advertising audio, and the result is stored in the memory unit 150.

Then, the control unit 100 transmits the information of the audibility and the effectiveness of the advertising audio to the server 30 that manages the advertisement (S114).

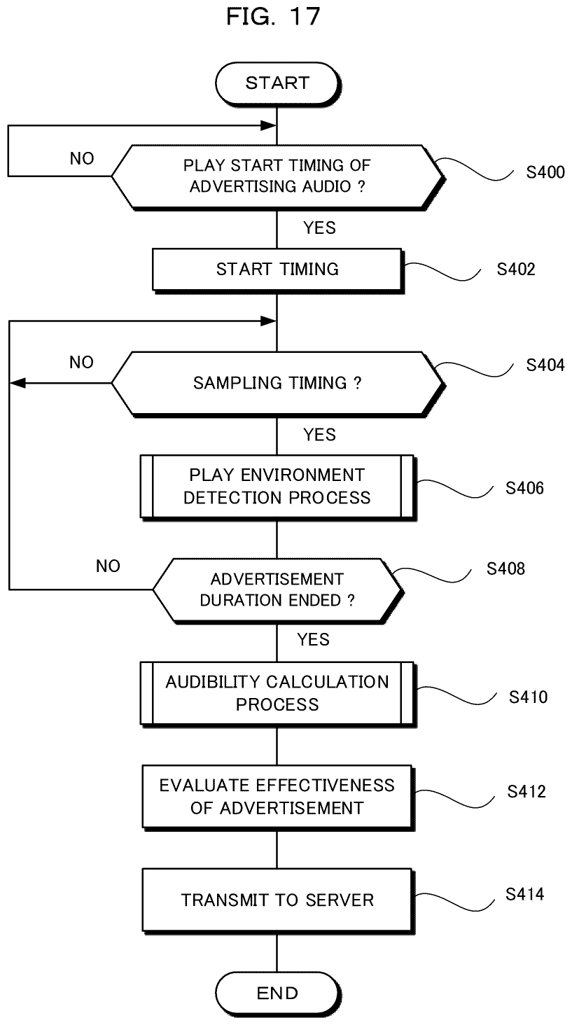

In FIG. 14, the example has been shown in the case where the audibility of the advertising audio is calculated at each sampling timing (e.g., in a cycle of 1 second). However, it is not intended to be limited to this example. For example, as illustrated in FIG. 17, it may be configured such that based on the play environment detected at each sampling timing in the audio advertisement duration, the audibility of the advertising audio is calculated after the end the audio advertisement duration. In the flowchart of FIG. 27, the processes in S400 to S406, S412, and S414 are the same as those of S100 to S106, S112 and S114 of the flowchart of FIG. 14, and a detailed description of each process is omitted.

In the processing example shown in FIG. 17, after the end of the audio advertisement duration (YES in S408), the control unit 100 calculates the audibility of the advertising audio based on the play environment detected at each sampling timing (S410). However, for example, the control unit 100 may calculate the audibility of the advertising audio based on the average of the play environment (volume, etc.) detected at each sampling timing. Alternatively, a batch processing may be adopted to calculate the audibility of the advertising audio for each sampling timing based on the play environment detected at each sampling timing.

In FIG. 14 or FIG. 17, examples have been shown in the case where the terminal device 10 performs the processes up to the process of evaluating the effectiveness of the advertising audio. However, it is not intended to be limited to these examples. For example, it may be configured such that the information of the audibility of the advertising audio calculated by the terminal device 10 is transmitted from the terminal device 10 to the server 30, and the evaluation of the effectiveness of the audio advertisement may be performed on the server 30 side that receives the audibility information.

Alternatively, as described below, it may be configured such that the information of the play environment detected by the play environment detection unit 120 of the terminal device 10 is transmitted from the terminal device 10 to the server 30, and the server 30 performs the calculation of the audibility of the advertising audio and the evaluation of the effectiveness of the audio advertisement.

In FIG. 14 or FIG. 17, examples have been shown in the case where every time one audio advertisement duration ends, the audio advertisement audibility information (or the advertising effectiveness information) is transmitted to the server 30. However, it is not intended to be limited to this example. For example, since the advertising audio is played multiple times in the game, the audibility information (or the advertising effectiveness information) of the advertising audio played in the game may be collected after the game ends, to be transmitted to the server 30. Alternatively, the information of the calculated audibility (or the advertising effectiveness information) can be stored in a storage device, and then transmitted from the terminal device 10 to the server 30 collectively for example, in a predetermined time unit such as a unit of an hour, a day, etc. In the case of offline games, at the timing the terminal device 10 logs in to the server 30, the information of the audibility (or the advertising effectiveness information) of the audio advertisement that has been played so far may be transmitted from the terminal device 10 to the server 30 collectively.

### 7. Considering Audio Advertisement Duration

Since the game is more interactive for the user, not all advertising audio will necessarily be played. For example, if an advertising audio is announced in the stadium as a performance during halftime of a soccer game, if the user skips halftime, the audio advertisement may be cut off in the middle.

In such case, if the audio advertisement has been played at a predetermined rate or longer (e.g., 80% or longer) of the original advertisement duration, the audibility of the advertising audio (or the coefficient that corrects the audibility) may be set to “1.0”, or the audibility (or the coefficient that corrects the audibility) may be defined according to the percentage of time played.

Additionally, if the runtime of the advertising audio is too short as the play of the advertising audio is stopped, the audibility of the advertising audio (or the coefficient that corrects the audibility) of the advertising audio can be set “0”. For example, if the run time from the start to the step of the advertising audio is within a predetermined time (e.g., within 1 second), the audibility of the advertising audio may be set “0”. Alternatively, if the ratio of the actual run time of the audio advertisement to the entire original audio advertisement duration is less than a predetermined percentage (e.g., 10% or less), the audibility of the advertising audio may can be set “0”.

Therefore, the audibility calculation unit 130 of the present embodiment may calculate the audibility of the advertising audio (referred to as the “sixth audibility”) based on a run time of the advertising audio of the entire audio advertisement duration.

Here, the “audio advertisement duration” refers to the duration “the audio advertisement” is performed by the advertising audio. In other words, the “audio advertisement duration” is the entire original duration of the audio advertisement. For example, in the case of a 10 seconds audio advertisement, 10 seconds from the start of the advertising audio is the “audio advertisement duration”.

The sixth audibility based on a run time of the advertising audio may be calculated only if the play of the advertising audio is stopped in the middle of the audio advertisement duration. Alternatively, regardless of whether the play of the advertising audio is stopped in the middle of the audio advertisement duration, the sixth audibility may be calculated.

For example, if the length of the entire audio advertisement duration is “t1(sec)” and the run time of the advertising audio is “t2(sec)”, for example, the sixth audibility A6 can be calculated by the following equation (9).

$$A 6 = t 2 / ( 0.8 \times t 1 ) \qquad ( 9 )$$

Here, if 0≤A6≤1 and the calculation result of equation (9) is A6>1, A6=1.

When calculating the audibility A of the advertising audio considering the sixth audibility A6, for example, the following equation (10) modified based on the above equation (7) can be applied.

$$A = A 1 \times A 2 \times A 3 \times A 4 \times A 5 \times A 6 \qquad ( 10 )$$

In the example of the above equation (10), the audibility A of the advertising audio may be calculated by omitting some of the applications of the first audibility A1 to the fifth audibility A5.

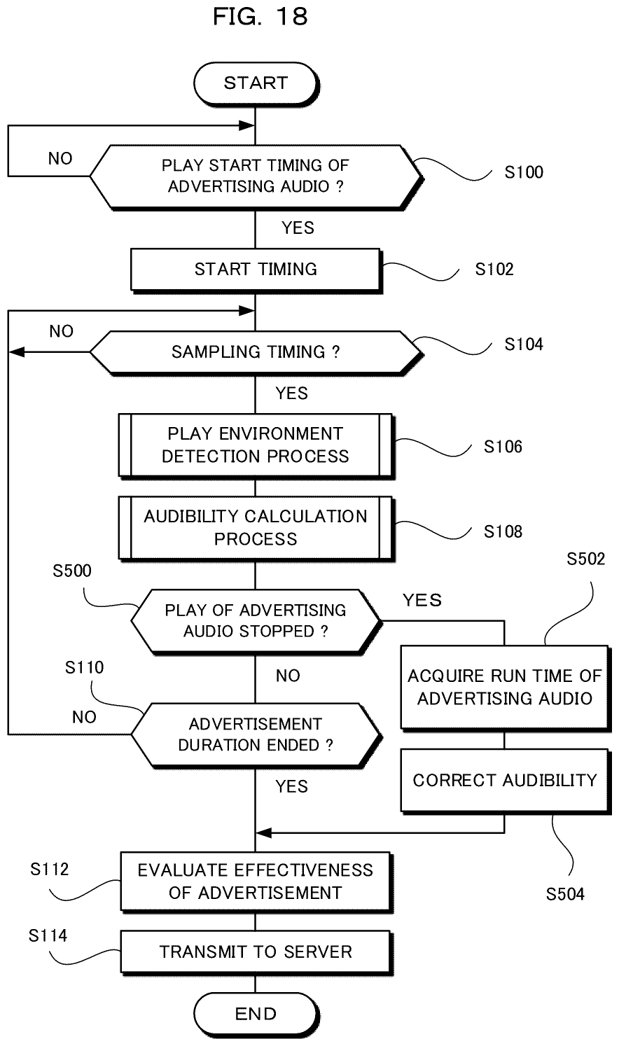

FIG. 18 is a flowchart illustrating an example of the processing of the present embodiment in consideration of the audio advertisement duration. In FIG. 18, the same steps as the steps of FIG. 14 are assigned the same step numbers, and the description thereof is omitted. In this processing example in FIG. 18, the step S500 is inserted into the loop processing of the steps S104 to S110 in the flowchart of FIG. 14 to determine whether the play of the advertising audio is stopped in the middle of the advertisement duration.

If the advertisement duration ends without being stopped in the middle of the advertisement duration (NO in S500 and YES in S110), the processes as those of FIG. 14 are executed.

On the other hand, if the play of the advertising audio is stopped in the middle of the advertisement duration (YES in S500), the control unit 100 acquires the runtime of the advertising audio (the time from the start to the stop of the play of the advertising audio) (S502). The control unit 100 then corrects the audibility calculated and stored in step S108 based on the run time of the advertising audio, and the corrected audibility is stored in the memory unit 150 (S504). For example, the control unit 100 calculates the sixth audibility A6 by applying the equation (9), and then calculates the audibility A incorporating the sixth audibility A6 by the equation (10). After step S504, the sequence proceeds to step S112.

### 8. Play Environment of Essential Part of Audio Advertisement

For the advertising audio, there may be an essential part as an advertisement. Therefore, it may be configured to consider such play environment of the essential part, to be reflected to the audibility of the advertising audio. For example, in the case of an audio advertisement saying “How about XX beer, the old-fashioned taste?”, the product name “XX beer” is considered to be the essential part of the advertisement. Specifically, it may be configured such that the information, indicating where such essential part is (for example, in the time period of 6 to 8 seconds) in the advertising duration, is set beforehand, and that a larger weight is assigned to the play environment of such essential part than a weight assigned to the play environment of other parts of the advertisement, to calculate the audibility of the advertising audio.

In view of the above, the audibility calculation unit 130 of the present embodiment may be configured such that a larger weight is assigned to a play environment of a specific essential period of the audio advertisement duration than a weight assigned to a play environment of other parts of the audio advertisement duration, to calculate the audibility of the advertising audio.

Here, the “specific essential period of the audio advertisement duration” is a specific period that is evaluated to be essential as an advertisement of the entire audio advertisement duration. For example, the specific period of the advertising duration, specified beforehand by an advertiser can be the “essential period”. Further, for example, the period in which the name of a product or a service is played or the name of an advertiser (such as a company name) is played, may also be referred to as the “essential period”.

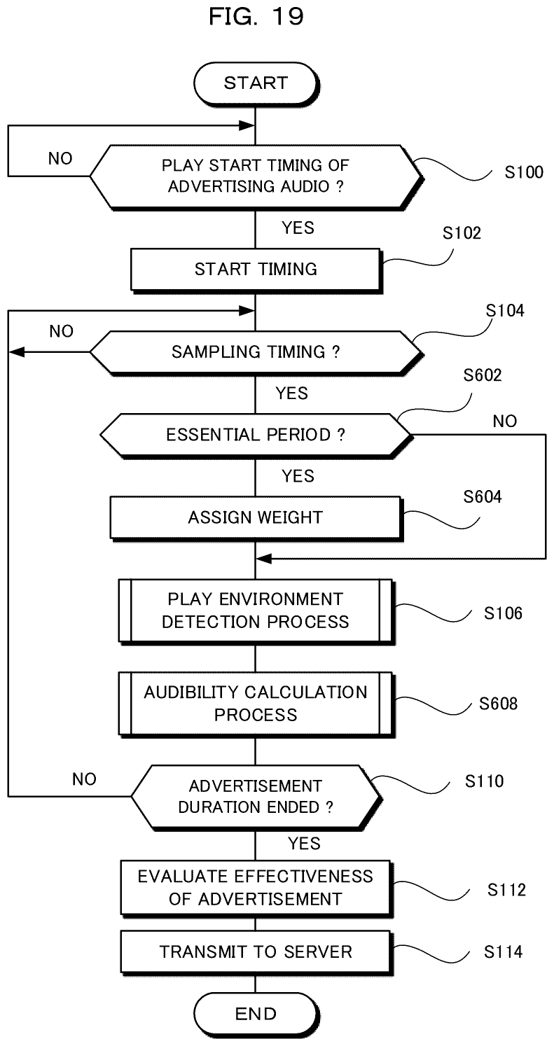

FIG. 19 is a flowchart illustrating an example of the processing according to the present embodiment, wherein the essential part of the advertising audio is taken into consideration. In FIG. 19, the processes that are same as those of FIG. 14 are assigned the same step numbers and the descriptions thereof are omitted. In this processing example of FIG. 19, if the sampling timing has come while the advertising audio is being played (YES in S104), the control unit 100 determines whether or not it is the essential period (S602). If it is the essential period (YES in S602), the control unit 100 sets a predetermined weight so that the audibility becomes larger than the audibility without the weight (S604). In the case where the weight is assigned, the control unit 100 calculates the audibility based on the play environment detected in S106 using the weight as assigned (S608). On the other hand, if it is not the essential period (NO in S602), the control unit 100 calculates the audibility based on the play environment detected in S106 without assigning the weight (S608).

Except that the weight as assigned is reflected in the case of assigning the weight in S604, the audibility calculation process of S608 of FIG. 19 is the same as the audibility calculation process of S108 of FIG. 14.

### 9. Summary

As described above, the program according to the present embodiment causes the terminal device 10 (an example of the computer) that executes the control of the game in which the advertising audio can be played to function as the play environment detection unit 120 and the audibility calculation unit 130. The terminal device 10 or the game system 1 (an example of the game control device) according to the present embodiment, that executes the control of the game in which advertising audio can be played, includes the play environment detection unit 120 and the audibility calculation unit 130.

The play environment detection unit 120 detects a play environment in the period related to the play of the advertising audio. The audibility calculation unit 130 calculates the audibility of the advertising audio based on the play environment detected by the play environment detection unit 120. According to this configuration, the audibility calculated based on the play environment in the period related to the play of the advertising audio can be used as an index to evaluate the effectiveness of the audio advertisement played in the game performed by the terminal device 10, which can improve the accuracy of evaluating the effectiveness of the audio advertisement.

The play environment can be the ON/OFF setting state of the audio output. The ON/OFF setting state of the audio output varies from user to user, and if the audio output is set OFF, the user cannot hear the advertising audio. Therefore, according to the above configuration, the audibility of the advertising audio can be accurately determined based on the ON/OFF setting state of the audio output in the period related to the play of the advertising audio.

The play environment can be the volume of the advertising audio. The higher the absolute volume of the advertising audio, the easier it is for a user to hear the advertising audio. Therefore, according to the above configuration, the audibility of the advertising audio can be accurately calculated based on the volume of the advertising audio in the period related to the play of the advertising audio.

The play environment can be the volume of the in-game audio including the advertising audio. The higher the absolute volume of the game audio including the advertising audio, the easier it is for the user to hear the advertising audio included in the game audio. Therefore, according to the above configuration, the audibility of the advertising audio can be accurately determined based on the volume of the game audio including the advertising audio in the period related to the play of the advertising audio.

The play environment can be a relative volume of the advertising audio to a volume of an in-game audio. The higher the volume of the advertising audio relative to the non-advertising audio, the easier it is for the user to hear the advertising audio included in the game audio. Therefore, according to the above configuration, the audibility of the advertising audio can be accurately determined based on the relative volume of the advertising audio to the non-advertising audio.

Further, the play environment can be the relative volume of the advertising audio limited to the specific frequency band to the volume of the in-game audio. The accuracy of the relative volume of the advertising audio in the game can be improved by limiting it to a specific frequency band that represents the characteristics of the advertising audio (e.g., a band of ±α % of the band peak, a band for discriminating consonants, etc.). Therefore, according to the above configuration, the audibility of the advertising audio can be calculated more accurately based on the relative volume of the advertising audio limited to the specific frequency band.

Further, the play environment detection unit 120 may be configured to divide the audio advertisement duration into multiple segment periods, set a specific frequency band for each segment period, and detect the relative volume of the advertising audio limited to the specific frequency band to the volume of the in-game audio for each segment period. Here, the specific frequency band set to at least one of several segment periods may be different from the specific frequency band set to the other segment periods. The audibility calculation unit 130 may calculate the audibility of the advertising audio based on the relative in-game volume for each segment period.

According to the above configuration, by considering the in-use bandwidth for each segment period and setting a specific frequency band for each segment period, it is possible to accurately calculate the audibility even for such advertising audio that has different in-use bands depending on a period within one audio advertisement.

The play environment may be with or without the use of headphones or earphones. In general, listening with headphones or earphones is easier to recognize audio than the case of listening through speakers due to such reasons as being able to play loud auditory, less likely to have noise entered, etc. Therefore, according to the above structure, the audibility of the advertising audio can be accurately determined based on the play environment with or without the use of headphones or earphones in the period related to the play of the advertising audio.

The play environment may be the visual information quantity of the visual displayed on the screen displaying the game. In general, the more information in the visual, the easier it is for a user to be aware of their vision, but the more difficult it is to be conscious of his/her hearing. Therefore, according to the above configuration, the audibility of the advertising audio can be accurately calculated based on the visual information quantity in the period related to the play of the advertising audio.

The audibility calculation unit 130 may be used to calculate the audibility based on the run time of the advertising audio to an entire audio advertisement duration. In this way, it is possible to accurately determine the audibility of the advertising audio based on the actual run time of the advertising audio to the entire audio advertisement duration, even if the entire audio advertisement duration has not been played.

The audibility calculation unit 130 may calculate the audibility by assigning a larger weight to the play environment in a specific essential period of the audio advertisement duration than a weight in other periods than the specific essential period. Namely, for the particularly essential period in the audio advertisement duration, by assigning a larger weight of the play environment than that of the other periods of the advertisement duration, it is possible to accurately calculate the audibility of the advertising audio.

### 10. Modifications, Etc

As described above, embodiments of the present invention have been described; however, the specific configuration is not limited to the above-described embodiments, but includes designs and the like within the scope of the invention. Further, each of the above-described configurations and embodiments can be arbitrarily combined.

[10-1] Other Use than dBFS

In the above description, the sound pressure level mainly in a unit of decibel (dBFS) has been used to calculate the “volume”, but is not limited thereto. As described above, for the detection of the “volume”, as long as the level of which can be quantitatively detected, for example, the loudness in a unit of “phon” may be used. By using the loudness instead of the sound pressure level in a unit of dBFS, it is expected that the accuracy of the calculated audibility of the advertising audio will be slightly improved.

### [10-2] Consideration of External Environmental Sound

In the above description, in the case where the play environment detected by the play environment detection unit 120 is the relative volume of the advertising audio to a volume other than the advertising audio, the audio in the terminal (in-game) is basically targeted. In the terminal device 10 having a microphone input, an external audio input from the microphone may be considered. In this case, an external audio (external environmental sound) is input by a microphone built into the terminal device 10 or a microphone connected to the terminal device 10 by wire or wirelessly. Then, the external environmental sound input from the microphone is treated as, for example, one of the channels of FIG. 7, and the play environment detection unit 120 detects the relative volume of the advertising audio to the volume other than the advertising audio, including the in-game audio and the external environmental sound. Further, the audibility calculation unit 130 calculates the audibility of the advertising audio (corresponding to the third audibility A3 described above) based on the relative volume of the advertising audio.

In the case of a play environment in which headphones or earphones are used, the external environment audio input from the microphone can be treated as a pure external environment audio that does not include the in-game audio. On the other hand, in the case of a play environment in which a speaker is used instead of headphones or earphones, the in-game audio is included in the external environment audio input from the microphone. Therefore, the input external environment audio may be treated in different manners between the play environment in which headphones or earphones are used and the play environment in which a speaker is used.

For example, in the play environment in which a speaker is used, audio waveform data in the opposite phase from the audio waveform data of the in-game audio is generated, and the audio waveform data as generated is superimposed on the audio waveform data of the input external environmental audio to reduce the influence of the in-game audio included in the external environmental audio. This reduced external environmental audio may be used.

Further, in the case of the play environment in which headphones or earphones are used, since the in-game audio is output around the user's ears, it can be said that it is less affected by external environmental audio than the case where a speaker is used. However, when the external environment audio reaches a certain volume, the influence of the external environment audio increases even in the case of using headphones or earphones. Therefore, in the play environment of using headphones or earphones, it may be configured to detect the relative volume of the advertising audio with respect to the volume other than the advertising audio including the external environmental audio only when the volume of the input external environment audio is in a predetermined level or higher, to calculate the audibility of the advertising audio.

[10-3] The terminal device 10 and the server 30 can communicate with each other to transmit and receive various data, and both are information processing devices (computers) equipped with a CPU, a ROM, a RAM, auxiliary storage devices, communication units, etc., which basically have the same configuration. Therefore, a part of the various functions described above may be realized by the CPU 11 of the terminal device 10, and the rest may be realized by the CPU 31 of the server 30. For example, the game system 1 may be configured such that the terminal device 10 includes the play environment detection unit 120, and the server 30 includes the audio calculation unit 130. In this configuration, the information of the play environment detected by the play environment detection unit 120 of the terminal device 10 is transmitted from the terminal device 10 to the server 30, and the audible calculation unit 130 of the server 30 calculates the audibility of the advertising audio based on the play environment received from the terminal device 10.

[10-4] In the above, explanations have been given through the case of the configuration example for detecting the play environment and calculating the audibility of the advertising audio in the terminal device 10 (the game terminal) that executes a game in which an advertising audio can be played. However, also in the viewing terminal of the case where the video of the gameplay executed by the terminal device 10 is distributed, the play environment can be detected in the same manner as described above, and the audibility of the advertising audio can be calculated. This will be described below.

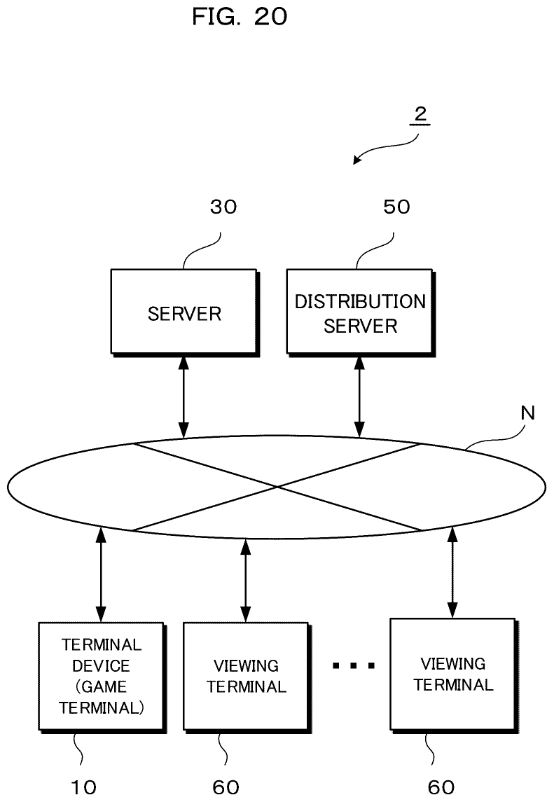

FIG. 20 is a schematic block diagram illustrating a configuration example of a distribution system 2 according to one embodiment of the present invention. The distribution system 2 includes the above-described terminal device 10, which is a game terminal, the server 30, the distribution server 50, and a viewing terminal 60. The control unit 100 of the terminal device 10 has a function of generating information on the play video of the game executed (hereinafter referred to as a gameplay video) and transmitting the information to the distribution server 50.

The distribution server 50 has a function of distributing the gameplay video received from the terminal device 10 to the viewing terminal 60. The hardware configuration of the distribution server 50 is the same as that of the server 30 (see FIG. 1), and thus the description thereof is omitted here. In the case where the server 30 has the distribution function of the distribution server 50, the distribution server 50 may be omitted.

Further, the hardware configuration of the viewing terminal 60 is the same as that of the terminal device 10 (see FIG. 1), and thus description thereof is omitted. The viewing terminal 60 has a function of viewing a video of the distributed gameplay. For example, in the case where the gameplay video can be viewed by a general-purpose web browser or an extension thereof (an example of a viewing program), various information processing devices having a browsing function can be used as the viewing terminal 60. Further, a dedicated viewing program may be installed on the viewing terminal 60 so that the gameplay video can be viewed. As the viewing terminal 60, for example, a personal computer, a tablet computer, a smartphone, a mobile phone terminal, a PHS terminal, a personal digital assistant (PDA), a home game machine (stationary or portable), a multifunctional television receiver, and the like can be used.

Here, in the viewing terminal 60, the advertising audio is played, for example, in the following two cases:
(1) the advertising audio is added to the audio of the gameplay video on the viewing terminal 60, and
(2) the advertising audio incorporated beforehand in the gameplay video is played.

In the case of the above (1), the viewing terminal 60 stores the audio advertisement information separately from the gameplay video, and adds the advertising audio to the audio of the gameplay video while the gameplay video is being played. In this case, the audio advertisement information is distributed from the server (the server 30 or the distribution server 50) having an advertisement management function to the viewing terminal 60 separately from the gameplay video (the gameplay video may or may not contain the advertising audio). In this case, the play method is basically the same as that of simply adding the advertising audio to the game audio in the above-described terminal device 10. Therefore, the above methods of calculating the audibility A1 to the audibility A6 of the first to the sixth advertising audio and the method of calculating the audibility by appropriately combining them can be applied to the viewing terminal 60 or the distribution system 2. In addition, the method of assigning a weight to the essential period of the audio advertisement, etc., can be applied as well.

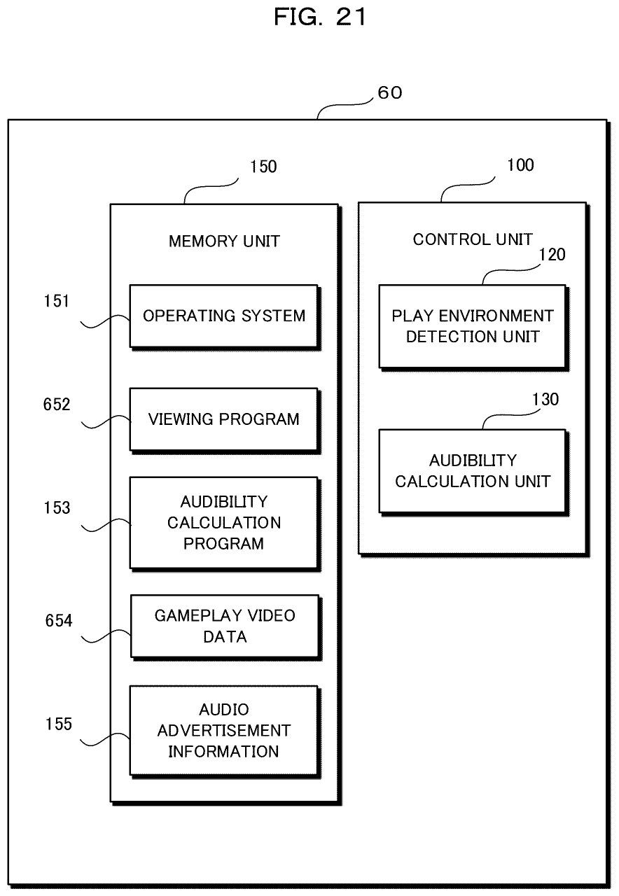

FIG. 21 is a schematic functional block diagram illustrating an example of the functional configuration of the viewing terminal 60. In FIG. 21, the configuration having the same function as the terminal device 10 is assigned the same reference numeral, and the description thereof is omitted. The memory unit 150 of the viewing terminal 60 stores the OS 151, a viewing program 652, the audibility calculation program 153, a gameplay video data 654, the audio advertisement information 155, and the like. Further, the control unit 100 of the viewing terminal 60 is realized by the CPU executing the OS 151, the viewing program 652, or the audibility calculation program 153. The control unit 100 of the viewing terminal 60 includes the play environment detection unit 120 and the audio calculation unit 130, which have the same function as that of the terminal device 10 described above.

In the case of the above (2), the user views at the viewing terminal 60, a gameplay video including the advertising audio as it is being played when executing the game on the terminal device 10. In this case, since the timing of playing the advertising audio at the viewing terminal 60 is not managed, the control unit 100 of the viewing terminal 60 needs to detect the timing of playing the advertising audio and the advertising period of the advertising audio. For example, the timing of playing the advertising audio can be detected in the following manner.

For example, the control unit 100 of the terminal device 10 transmits the information related to the advertising audio played when executing the game to the distribution server 50 in relation to the gameplay video. Here, the information related to the advertising audio includes time-sensitive information indicating where the audio advertisement duration is in the gameplay video. For example, the information on the advertising audio is recorded in the header of a predetermined file structure of the gameplay video. The distribution server 50 also distributes the information on the advertising audio associated with the gameplay video to the viewing terminal 60. The control unit 100 of the viewing terminal 60 detects the timing of playing the advertising audio and the advertising duration based on the information on the advertising audio associated with the gameplay video.

The control unit 100 of the viewing terminal 60 detects as the play environment as described above, the ON/OFF setting state of the audio output, the absolute volume of the in-game audio including the advertising audio, with or without the user of headphones or earphones, or the visual information quantity, and calculates the audibility of the advertising audio (the first audibility, the second audibility, the fourth audibility, the fifth audibility audibility, and the audibility of a combination thereof).

Further, the information on the relative in-game volume of the advertising audio may be included in the information on the advertising audio associated with the gameplay video. That is, the control unit 100 of the terminal device 10, i.e., a game terminal, stores the in-game relative volume of the advertising audio as detected in the above-described manner in association with the generated gameplay video. In this case, the control unit 100 of the viewing terminal 60 can also calculate the third audibility based on the relative in-game volume by acquiring the relative in-game volume of the advertising audio associated with the gameplay video.

As the information related to the advertising audio associated with the gameplay video, the visual information quantity detected by the terminal device 10 may be included. In this case, the viewing terminal 60 can easily calculate the fifth audibility simply by acquiring the visual information quantity associated with the gameplay video.

Further, the above-mentioned sixth audibility considering the run time of the audio advertisement, assigning a weight to the essential period of the audio advertisement, and the like can be applied in the same way.

As described above, the viewing terminal 60 that views the distributed gameplay video can also detect the play environment in the period related to the play of the advertising audio, and calculates the audibility of the advertising audio based on the detected play environment.

The program according to the present embodiment causes the viewing terminal 60 (one example of the computer) that can play the gameplay video, to function as the play environment detection unit 120 that detects a play environment in a period related to a play of the advertising audio; and the audibility calculation unit 130 that calculates the audibility of the advertising audio based on the play environment detected by the play environment detection unit 120.

Further, the viewing terminal 60 according to the present embodiment is capable of playing the gameplay video, and includes the play environment detection unit 120 and the audibility calculation unit 130.

Further, the distribution system 2 according to the present embodiment includes a server (the server 30 and/or the distribution server 50) and the viewing terminal 60 that can communicate with the server, includes the play environment detection unit 120 and the audibility calculation unit 130. For example, the play environment detection unit 120 and the audibility calculation unit 130 may be provided on the viewing terminal 60, or the play environment detection unit 120 may be provided on the side of the viewing terminal 60, and the audibility calculation unit 130 may be provided on the side of the server.

The method of controlling the viewing terminal 60 (one example of the computer) according to the present embodiment that can play the gameplay video includes a play environment detecting step of detecting a play environment in a period related to the play of the advertising audio; and an audibility calculating step of calculating an audibility of the advertising audio based on the play environment as detected.

(Configuration of Associating Audibility Information of Advertising Audio with Gameplay Video)

In the case of the above (2), the above-described “advertising audio information” associated with the gameplay video may include the information on the audibility of the advertising audio calculated by the terminal device 10 or the server (the server 30 or the distribution server 50).

For example, the control unit 100 of the terminal device 10 (an example of the game terminal) is configured when generating a gameplay video, to associate to the gameplay video, the “information on the advertising audio” including the time-sensitive information of the audio advertisement duration and the audibility information of the advertising audio calculated in the described manner. Then, the control unit 100 of the terminal device 10 transmits a gameplay video associated with the information on the advertising audio to the distribution server 50 (an example of the server). The control unit 100 of the terminal device 10 transmits the gameplay video associated with the information on the advertising audio to the distribution server 50 (an example of the server). The distribution server 50 distributes the gameplay video associated with the information on the advertising audio to the viewing terminal 60. As a result, the control unit 100 of the viewing terminal 60 determines whether or not the advertising audio in the advertising period is viewed while viewing the gameplay video based on the time-sensitive information of the advertising period, and if it is determined that the advertising audio has been viewed, it is possible to calculate the audibility of the advertising audio by obtaining the information on the audibility of the advertising audio associated with the gameplay video. With this configuration, the viewing terminal 60 can easily calculate the audibility of the advertising audio only by determining whether or not the advertising audio in the audio advertisement duration has been viewed.

Here, for the information on the audibility of the advertising audio associated with the gameplay video is the information on the audibility of the advertising audio in which the audibility on the side of the terminal device 10, which is a game terminal, can be applied also to the audibility on the side of the viewing terminal 60. For example, the fourth audibility based on with or without the use of headphones or earphones on the side of the terminal device 10 does not affect the audibility of the advertising audio on the side of the viewing terminal 60. Therefore, the fourth audibility does not need to be associated with the gameplay video. For the information on the audibility of the advertising audio associated with the gameplay video, for example, at least one of the first, the second, the third, the fifth, or the sixth audibility, or any combination thereof can be used. Therefore, the control unit 100 of the viewing terminal 60 can easily calculate the audibility of the advertising audio on the side of the viewing terminal 60 (e.g., the first, the second, the third, the fifth, the sixth audibility, or of the first, second, third, fifth, sixth, or an arbitrary combination thereof) based on the information on the audibility of the advertising audio associated with the gameplay video.

The process of associating the information on the audibility of the advertising audio (or the information on the the advertising audio including the information on the audibility of the advertising audio) with the gameplay video may be executed by the server (the server 30 or the distribution server 50) instead of the terminal device 10. For example, in the above configuration wherein the audibility calculation unit 130 is provided on the server side, the control unit of the server may perform the process of associating the information on the audibility of the advertising audio with the gameplay audio.

The control unit 100 of the viewing terminal 60 may calculate a comprehensive audibility of the advertising audio by combining “the audibility of the advertising audio calculated based on the information on the audibility of the advertising audio associated with the gameplay video” and “the audibility of the advertising audio calculated based on the play environment (or the audio advertisement duration) detected by the viewing terminal 60”.

For example, the control unit 100 of the viewing terminal 60 calculates the first, the second, the third, and the fifth audibility A1, A2, A3, and A5 based on the information on the audibility of the advertising audio associated with the gameplay video. Further, the control unit 100 of the viewing terminal 60 detects the play environment of with or without the use of headphones or earphones on the side of the viewing terminal 60 and calculates the fourth audibility A4. Then, the control unit 100 of the viewing terminal 60 combines the above audibility to calculate the comprehensive audibility A of the advertising audio reflecting the first audibility A1 to the fifth audibility A5 (for example, the above equation (7) is applied).

For example, it may be configured such that the control unit 100 of the viewing terminal 60 calculates the third and fifth audibility A3 and A5 based on the information of the audibility of the advertising audio associated with the gameplay video, and calculates the first, the second and the fourth audibility A1, A2, and A4 based on the play environment detected by the viewing terminal 60, and then calculate the comprehensive audibility A of the advertising audio by combining the above audibility.

Not limited to the above examples, the audibility of the advertising audio calculated based on the information on the audibility associated with the gameplay video can be at least one of the first, the second, the third, the fifth, and the sixth audibility. In addition, the audibility of the advertising audio calculated based on the play environment (or the audio advertisement duration) detected by the viewing terminal 60 is at least one of the first to the sixth audibility.

For the first audibility based on the ON/OFF setting state of the audio output, it may be configured to differ the processing on the side of the viewing terminal 60 depending on whether the first audibility of the advertising audio associated with the gameplay video is “0” or not.

In other words, if the first audibility of the advertising audio associated with the gameplay video is “0” (in this case, the gameplay video is muted during the audio advertisement duration), the first audibility “0” may be applied as it is on the side of the viewing terminal 60. On the other hand, even if the first audibility of the advertising audio associated with the gameplay video is not “0” (for example, “1”), if the user of the viewing terminal 60 sets the audio output to OFF, the audio itself will not be output from the viewing terminal 60, and the user will not be able to listen to the advertising audio. Therefore, if the first audibility of the advertising audio associated with the gameplay video is not “0”, it is preferable to determine the first audibility after detecting the ON/OFF setting state of the audio output on the side of the viewing terminal 60.

For the second audibility based on the “volume of the advertising audio” or the “volume of the in-game audio including the advertising audio (i.e., the volume of the gameplay video)”, the second audibility of the advertising audio associated with the gameplay video may be applied on the side of the viewing terminal 60 as it is; however, the second audibility corrected in the following manner may be applied on the side of the viewing terminal 60. Namely, a user of the viewing terminal 60 can adjust the volume (absolute volume) of the gameplay video including the advertising audio, on the side of the viewing terminal 60. For example, the volume of gameplay video output from the viewing terminal 60 may change by setting the volume based on the optional setting in the viewing program executed on the viewing terminal 60 or by setting the volume based on the OS management. Therefore, the smaller the volume of the gameplay video output from the viewing terminal 60, the lower the audibility of the second audibility of the advertising audio associated with the gameplay video, and the second audibility as corrected can be applied to the second audibility of the viewing terminal 60.

As described, the program according to the present embodiment, that when a gameplay video that may contain an advertising audio is viewed on the viewing terminal 60 (an example of a computer), that executes the process of calculating the audibility of the advertising audio, wherein a time-sensitive information of an audio advertisement information in a gameplay video and an information on an audibility of the advertising audio are associated with the gameplay vide, causes the viewing terminal 60 to function as an advertising audio play determination unit that determines whether or not the audio advertisement duration has been played while viewing the gameplay video based on the time-sensitive information associated with the gameplay video; and an audibility calculation unit that calculates the audibility of the advertising audio on the viewing terminal 60 based on the information on the audibility of the advertising audio associated with the gameplay video when it is determined by the advertising audio play determination unit that the advertising audio has been played.

The program according to the present embodiment may further cause the viewing terminal 60 to function as the play environment detection unit that detects a play environment in a period related to the play of advertising audio, wherein the audibility calculation unit calculates the audibility of the advertising audio on the viewing terminal 60 based on at least either one of the information on the audibility of the advertising audio associated with the gameplay video and the play environment.

The program according to the present embodiment causes the terminal device 10 that can communicate with the server that distributes a gameplay video to the viewing terminal 60, and executes a game in which the advertising audio can be played, and a process of generating the gameplay video as a result of executing the game to function as the play environment detection section 120 that detects the play environment in the period related to the play of the advertising audio; the audibility calculation unit 130 that calculates the audibility of the advertising audio based on the play environment detected by the play environment detection unit 120, the association unit that associates the time-sensitive information of the audio advertisement duration and the audibility information of the advertising audio in the gameplay video with the gameplay video; and the transmit unit that transmits the gameplay video associated with the time-sensitive information and the audibility information of the advertising audio to the server.

The distribution system 2 according to the present embodiment, including the terminal device 10 (an example of the game terminal) that executes a game in which an advertising audio can be played, and generates a gameplay video as a result of executing the game, a server (a server 30 or a distribution server 50) that receives the gameplay video from the terminal device 10 and distributes the gameplay video as received, and a viewing terminal 60 that views the gameplay video as distributed, wherein the terminal device 10 includes a play environment detection unit that detects a play environment in a period related to a play of the advertising audio; the terminal device 10 or the server includes an audibility calculation unit that calculates the audibility of the advertising audio based on the play environment detected by the play environment detection unit, and an association unit that associates a time-sensitive information of the advertising audio duration and the information on the audibility of the advertising audio with the gameplay video; and the viewing terminal 60 includes the advertising audio play determination unit that determines whether or not the audio advertisement duration has been played while viewing the gameplay video based on the time-sensitive information associated with the gameplay video, and the audibility calculation unit that calculates the audibility of the advertising audio on the viewing terminal 60 based on the information on the audibility of the advertising audio associated with the gameplay video when it is determined by the advertising audio play determination unit that the advertising audio has been played.

[10-5] In the above, explanations have been given through the example configuration that detects the play environment and calculates the audibility of the advertising audio for the content of the game (the game to be played by the user or the gameplay video to be distributed). However, not only for games but also for other content, it is possible to detect the play environment and calculates the audibility of the advertising audio in the same manner as above.

Here, the “content” may include various content that can be viewed by the user, such as movies, dramas, music videos, other visual, music, e-book readings of novels, etc.

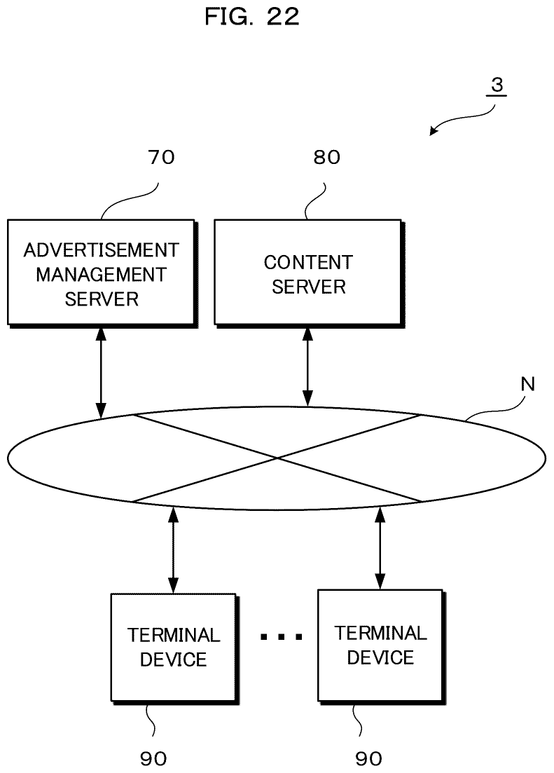

FIG. 22 is a schematic block diagram illustrating an example configuration of a content system 3 according to one embodiment of the present invention. The content system 3 includes a terminal device 90, that is a content viewing terminal, an advertisement management server 70, and a content server 80. The advertisement management server 70 has the same function as the advertisement management function of the server 30 mentioned above. The content server 80 has the function of distributing content data to the terminal unit 90. In addition, the advertisement management server 70 and the content server 80 can be integrated and configured as one server. The hardware configuration of the advertisement management server 70 or the content server 80 is the same as that of the server 30 (see FIG. 1), and the description thereof is omitted.

Further, the hardware configuration of the terminal device 90 is the same as that of the terminal device 10 (see FIG. 1), and the description thereof is omitted. The terminal device 90 has the function of playing a content. The content may be played on the terminal device 90 simultaneously while downloading the content data, for example, by the streaming method. Alternatively, the user may play the content at any time after the download of the content data on the terminal device 90 is completed. As the terminal device 90, for example, personal computers, tablet computers, smartphones, mobile phone terminals, PHS terminals, portable information terminals (PDAs), home game consoles (stationary or portable type), multi-function television receivers, etc. can be used.

In the terminal device 90, the audio advertisement information is stored separately from the content data, and the advertising audio is added to the content audio while the content is being played. This is basically the same as the play method in which the advertising audio is simply added to the game audio in the terminal device 10 mentioned above. Therefore, the method of calculating the first to the sixth audibility A1 to A6 of the advertising audio, and the method of calculating the comprehensive audibility by combining them can be applied to the terminal device 90 or the content system 3. The same can be applied to the case of assigning a weight to the essential period of the audio advertisement.

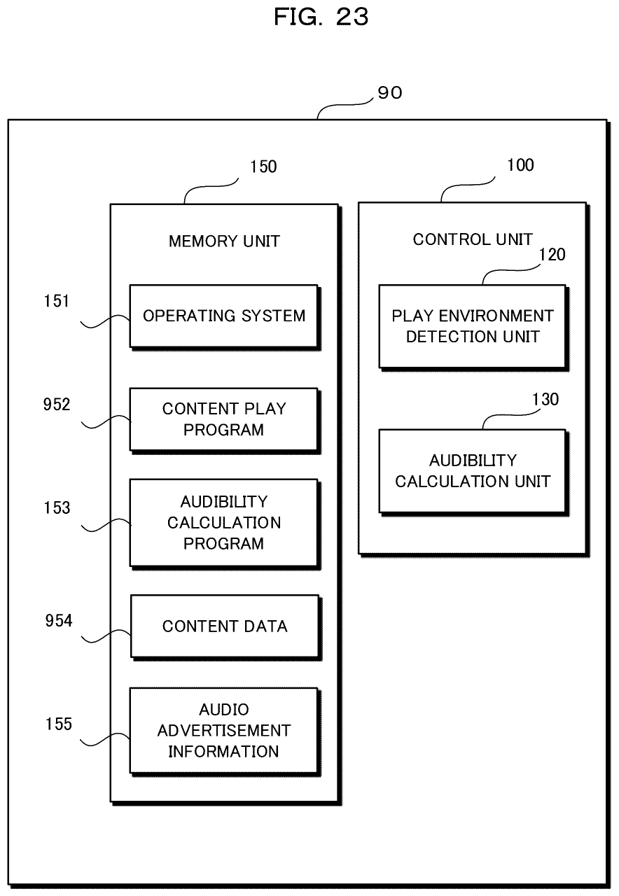

FIG. 23 is a schematic functional block diagram illustrating an example of the functional configuration of the terminal device 90. In FIG. 23, the configuration having the same function as that of the terminal device 10 is given the same reference numeral, and the description thereof is omitted. The memory unit 150 of the terminal device 90 stores the OS 151, a content play program 952, the audibility calculation program 153, a content data 954, and the audio advertisement information 155, etc. Further, the control unit 100 of the terminal device 90 is realized by the CPU executing the OS 151, the content play program 952, or the audibility calculation program 153. The control unit 100 of the terminal device 90 includes the play environment detection unit 120 and the audibility calculation unit 130, which have the same functions as those of the terminal device 10 mentioned above.

As described, even in the terminal device 90 that can play various contents, it is possible to detect the play environment in the period related to the play of the advertising audio, and calculate the audibility of the advertising audio based on the detected play environment.

The program according to the present embodiment causes the terminal device 90 (an example of the computer) that can play a content to function as the play environment detection unit 120 that detects the play environment of the period related to the play of advertising audio, and the audibility calculation unit 130 that calculates the audibility of the advertising audio based on the play environment.

Further, the terminal device 90 according to the present embodiment that can play the content includes the play environment detection unit 120 and the audibility calculating unit 130.

Further, the content system 3 according to the present embodiment includes the server (the advertisement management server 70 and/or the content server 80) and the terminal device 90 that can communicate with the server includes the play environment detection section 120 and the audibility calculation unit 130. For example, the play environment detection unit 120 and the audibility calculation unit 130 may be provided on the side of the terminal device 90, or the play environment detection unit 120 may be provided on the side of the terminal device 90, and the audibility calculation unit 130 may be provided on the server side.

In addition, the control method of controlling the terminal device 90 (an example of the computer) that can play a content includes: a play environment detection step of detecting the play environment of the period related to the play of the advertising audio, and the audibility calculation step of calculating the audibility of the advertising audio based on the play environment detected by the play environment detection step.

[10-6]

A part or all of the functions of the control unit 100 described above may be realized by an integrated circuit such as LSI (Large Scale Integration), etc. Further, it may be configured that each of the above functions is integrated into a processor individually. Alternatively, some or all of the above-described functions may be integrated into a processor.

[10-7]

The computer-readable program of the present embodiment is stored in various types of computer-readable storage medium such as a hard disk, an optical disk (CD-ROM, DVD-ROM, etc.), a flexible disk, a semiconductor memory, or the like. The program is read out from the storage medium and executed by a computer constituting the game system 1, the terminal device 10 or the server 30. Further, a program can be provided to the computer via a network including a communication line such as the Internet, WAN, LAN, or a dedicated line. A program stored in a file server (online storage) may be read out by a computer. Further, a computer may receive a program delivered from a distribution server. The storage medium also includes a storage medium provided in or outside the distribution server, accessible from the distribution server for distributing a program. A program code stored on the storage medium of the distribution server may not be in a code form that can be directly executed on the computer that received the program. Namely, as long as the program is executable by the computer after the download from the distribution server, the format of the program stored in the storage medium of the distribution server is arbitrary. Further, the program may be divided when downloading, and a plurality of divided programs may be merged after being downloaded respectively at different timings. Further, the distribution server that distributes each of the divided programs may not be the same. Further, the computer-readable storage medium includes those temporarily hold a program, such as a volatile memory like a RAM in a server that transmits a program via a network or a computer that receives it. Further, the program may be a differential program that can realize the above-described function in combination with a program already stored on the computer.

### 11. Appendixes

From the above description, the present invention can be understood, for example, as follows. In order to clarify each aspect, reference numerals in the drawings are appended below in parentheses for convenience. However, the present invention is not limited to the drawings.

1) A program according to one aspect of the present invention causes a computer that executes a control of a game in which an advertising audio can be played, to function as a play environment detection unit (120) that detects a play environment in a period related to a play of the advertising audio; and an audibility calculation unit (130) that calculates the audibility of the advertising audio based on the play environment detected by the play environment detection unit.

Here, for the “computer”, any computer including at least a processor and a storage device (memory) may be adopted. The processor is, for example, a CPU (Central Processing Unit). The processor 13 include a hardware such as a GPU (Graphics Processing Unit), a DSP (Digital Signal Processor), or an FPGA (Field Programmable Gate Array) in addition to or instead of the CPU. For example, any of those including a processor and a storage device are included in the “computer”, such as a personal computer, a tablet computer, a smartphone, a stationary or portable game console, a commercial game console, a mobile phone terminal, a PHS terminal, a PDA, a multi-function television receiver with an information processing function, etc. Further, the “computer” may be composed of a plurality of devices capable of communicating. For example, a system including a server and a terminal device is also included in the “computer”.

2) According to one aspect of the present invention, in the above aspect 1), the play environment includes an ON/OFF setting state of an audio output.

3) According to one aspect of the present invention, in the above aspect 1) or 2), the play environment includes a volume of the advertising audio.

4) According to one aspect of the present invention, in the above aspect 1) or 2), the play environment includes a volume of an in-game audio including the advertising audio.

5) According to one aspect of the present invention, in any of the above aspects 1) to 4), the play environment includes a relative volume of the advertising audio to a volume of an in-game audio.

6) According to one aspect of the present invention, in any of the above aspects 1) to 5), the play environment includes a relative volume of the advertising audio limited to a specific frequency band to a volume of an in-game audio.

7) According to one aspect of the present invention, in any of the above aspects 1) to 6), the play environment includes with or without a use of headphones or earphones.

8) According to one aspect of the present invention, in any of the above aspects 1) to 7), the play environment includes an information quantity of a visual displayed on a screen displaying the game.

9) According to one aspect of the present invention, in any of the above aspects 1) to 8), the audibility calculation unit (130) calculates the audibility based on a run time of the advertising audio to an entire audio advertisement duration.

10) According to one aspect of the present invention, in any of the above aspects 1) to 9), the audibility calculation unit (130) calculates the audibility by assigning a larger weight to the play environment in a specific essential period of an audio advertisement duration than a weight of the play environment in other period than the specific essential period of the audio advertisement duration.

11) According to one aspect of the present invention, in the above aspect 6), the playback environment detection unit (120) divides the audio advertising duration into multiple segment periods, sets a specific frequency band to each segment period, and detects a relative volume of the advertising audio limited to a specific frequency band to a volume of an in-game audio for said each segment period. In this case, the specific frequency band set to at least one of the multiple segment periods may be different from the specific frequency band set to the other segment periods.

12) A game control device (1, 10, 30) according to one aspect of the present invention, executing a control of s game in which an advertising audio can be played, includes a play environment detection unit (120) that detects a play environment in a period related to a play of the advertising audio; and an audibility calculation unit (130) that calculates the audibility of the advertising audio based on the play environment detected by the play environment detection unit (120).

13) A game system (1) according to one aspect of the present invention, including a server (30) and a terminal device (10) that can communicate with the server, executing a control of the game in which an advertising audio can be played, includes a play environment detection unit (120) that detects a play environment in a period related to a play of the advertising audio; and an audibility calculation unit (130) that calculates the audibility of the advertising audio based on the play environment detected by the play environment detection unit (120).

14) A control method according to one aspect of the present invention, controlling a computer executing a control of a game in which an advertising audio can be played, includes a play environment detection step (S106, S406) of detecting a play environment in a period related to a play of the advertising audio; and an audibility calculation step (S108, S410, S608) of calculating the audibility of the advertising audio based on the play environment detected by the play environment detection step.

15) A program according to one aspect of the present invention, causes a computer (60) that can play a gameplay video to function as a play environment detection unit (120) that detects a play environment in a period related to a play of the advertising audio; and an audibility calculation unit (130) that calculates the audibility of the advertising audio based on the play environment detected by the play environment detection unit (120).

16) A viewing terminal (60) according to one aspect of the present invention, that can play a gameplay video, includes a play environment detection unit (120) that detects a play environment in a period related to a play of the advertising audio; and an audibility calculation unit (130) that calculates the audibility of the advertising audio based on the play environment detected by the play environment detection unit.

17) A distribution system (2) according to one aspect of the present invention, including a server (30, 50) and a viewing terminal (60) that can communicate with the server, that can play a gameplay video on the viewing terminal, includes a play environment detection unit (120) that detects a play environment in a period related to a play of the advertising audio; and an audibility calculation unit (130) that calculates the audibility of the advertising audio based on the play environment detected by the play environment detection unit.

18) A control method according to one aspect of the present invention, for controlling a computer that can play a gameplay video, includes a play environment detection step (S106, S406) of detecting a play environment in a period related to a play of the advertising audio; and an audibility calculation step (S108, S410, S608) of calculating the audibility of the advertising audio based on the play environment detected by the play environment detection step.

19) A program according to one aspect of the present invention, causes a computer (60) that can play an advertising audio while a content is being played to function as a play environment detection unit (120) that detects a play environment in a period related to a play of the advertising audio; and an audibility calculation unit (130) that calculates the audibility of the advertising audio based on the play environment detected by the play environment detection unit.

20) A terminal device (90) according to one aspect of the present invention, that can play an advertising audio while a content is being played, includes a play environment detection unit (120) that detects a play environment in a period related to a play of the advertising audio; and an audibility calculation unit (130) that calculates the audibility of the advertising audio based on the play environment detected by the play environment detection unit.

21) A content system (3) according to one aspect of the present invention, including a server (70, 80) and a terminal device (90) that can communicate with the server, that can play an advertising audio while a content is being played, includes a play environment detection unit (120) that detects a play environment in a period related to a play of the advertising audio; and an audibility calculation unit (130) that calculates the audibility of the advertising audio based on the play environment detected by the play environment detection unit.

22) A control method according to one aspect of the present invention for controlling a computer that can play an advertising audio while a content is being played includes a play environment detection step (S106, S406) of detecting a play environment in a period related to a play of the advertising audio; and an audibility calculation step (S108, S410, S608) of calculating an audibility of the advertising audio based on the play environment detected by the play environment detection step.

23) An information storage medium according to one aspect of the present invention is a computer-readable storage medium storing the program of any of the above aspects 1) to 11), 15) and 19).

Note that the embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### DESCRIPTION OF REFERENCE SIGNS

1 . . . game system
N . . . network
DB . . . database
10 . . . terminal device
11 . . . CPU
13 . . . RAM
14 . . . auxiliary storage device
17 . . . display unit
18 . . . audio output unit
30 . . . server
31 . . . CPU
33 . . . RAM
34 . . . auxiliary storage device
35 . . . communication unit
100 . . . control unit
110 . . . game control unit
111 . . . output control unit
120 . . . play environment detection unit
121 . . . audio output setting detection unit
122 . . . absolute volume detection unit
123 . . . relative volume detection unit
124 . . . in-use audio generating device detection unit
125 . . . visual information quantity detection unit
130 . . . audibility calculation unit
1231 . . . specific frequency band setting unit
1232 . . . spectral analysis unit
1233 . . . advertisement volume detection unit
1234 . . . non-advertisement volume detection unit
1235 . . . in-game relative volume calculation unit
2 . . . distribution system
50 . . . distribution server
60 . . . viewing terminal
3 . . . content system
70 . . . advertisement management server
80 . . . content server
90 . . . terminal device
AD . . . audio advertisement
150 . . . memory unit
151 . . . operating system
152 . . . game program
153 . . . audibility calculation program
154 . . . game data
155 . . . audio advertisement information
652 . . . viewing program
654 . . . gameplay video data
954 . . . content data

What is claimed is:

1. A non-transitory computer-readable storage medium having recorded therein a program for controlling a game in which an advertising audio can be played and that is executed by a processor of an information processing apparatus, the program causing the processor to:
detect a play environment in a period related to a play of the advertising audio; and
calculate an audibility of the advertising audio based on the play environment as detected.

2. The storage medium of claim 1, wherein:
the play environment includes an ON/OFF setting state of an audio output.

3. The storage medium of claim 1, wherein:
the play environment includes a volume of the advertising audio.

4. The storage medium of claim 1, wherein:
the play environment includes a volume of an in-game audio including the advertising audio.

5. The storage medium of claim 1, wherein:
the play environment includes a relative volume of the advertising audio to a volume of an in-game audio.

6. The storage medium of claim 1, wherein:
the play environment includes a relative volume of the advertising audio limited to a specific frequency band to a volume of an in-game audio.

7. The storage medium of claim 1, wherein:
the play environment includes with or without a use of headphones or earphones.

8. The storage medium of claim 1, wherein:
the play environment includes an information quantity of a visual displayed on a screen displaying the game.

9. The storage medium of claim 1, wherein:
the program causes the processor to:
calculate the audibility based on a run time of the advertising audio to an entire audio advertisement duration.

10. The storage medium of claim 1, wherein:
the program causes the processor to:
calculate the audibility by assigning a larger weight to the play environment in a specific essential period of an audio advertisement duration than a weight of the play environment in other period than the specific essential period of the audio advertisement duration.

11. A game control device comprising at least one processor, and a memory cooperating with the processor and storing an instruction executable by the processor, that, when executed by the processor, a program for controlling a game in which an advertising audio can be played, causes the processor to:
detect a play environment in a period related to a play of the advertising audio; and
calculate an audibility of the advertising audio based on the play environment as detected.

12. A control method for controlling a game in which an advertising audio can be played, comprising:
detecting a play environment in a period related to a play of the advertising audio; and
calculating an audibility of the advertising audio based on the play environment as detected.
